(19) United States
(12) Patent Application Publication
(10) Pub. No.: US 2023/0189139 A1
(43) Pub. Date: Jun. 15, 2023

(54) WAKE-UP SIGNALS AND ADAPTIVE NUMEROLOGY

(71) Applicant: Sony Group Corporation, Tokyo (JP)

(72) Inventors: Basuki PRIYANTO, Lund (SE); Rickard LJUNG, Helsingborg (SE); Peter KARLSSON, Lund (SE); Nafiseh MAZLOUM, Lund (SE)

(21) Appl. No.: 17/431,918

(22) PCT Filed: Mar. 20, 2020
(86) PCT No.: PCT/EP2020/057795

§ 371 Date: Aug. 18, 2021

(30) Foreign Application Priority Data
Mar. 29, 2019 (SE) 1930102-7

(51) Int. Cl. H04W 52/02; H04L 27/26

(52) U.S. Cl. CPC H04W 52/0212; H04L 27/26025

(57) ABSTRACT

A count of one or more subcarriers (811-818) of a carrier (370) is determined depending on a setting of an adaptive modulation numerology of the carrier (370). A wake-up signal (4003) is transmitted to a wireless communication device (101) on the one or more subcarriers (811-818).

### TECHNICAL FIELD

Various examples of the invention generally relate to wake-up signals. Various examples of the invention specifically relate to strategies for transmitting wake-up signals on a carrier having an adaptive modulation numerology.

### BACKGROUND

Wireless communication often employs battery-powered devices (hereinafter, UE) that can connect to an access node to transmit and/or receive (communicate) data. To reduce energy consumption, low-power modes are sometimes employed. When the UE is operated in such a low-power mode, an associated access node transmits an appropriate signal to prepare the UE for subsequent communication of data (a process sometimes referred to as paging).

There are various paging signals known that are employed in connection with paging. A new concept of paging signals, the so-called wake-up signal (WUS), has been introduced in the Third Generation Partnership (3GPP) to Machine Type Communication (MTC) and Narrowband Internet of Things (NB-IoT) protocols. The objective of the WUS is to reduce the total energy cost in the UE for listening for paging signals. The WUS is expected to be sent at or prior to a paging occasion (PO) prior to further paging signals, such as a paging indicator on a physical data control channel. Examples of physical data control channels include Physical Downlink Control Channel (PDDCH) in 3GPP 4G or 5G, or MTC PDDCH (MPDCCH) or NB-IoT PDCCH (NPDCCH). The UE may selectively decode the physical data control channel and the subsequent data shared channel—such as the Physical Data Shared Channel (PDSCH)—for a further paging signal, the paging message, upon detecting the WUS.

Example implementations of WUSs are described in 3GPP TSG RAN Meeting #74 contribution RP-162286 “Motivation for New WI on Even further enhanced MTC for LTE”; 3GPP TSG RAN Meeting #74 contribution RP-162126 “Enhancements for Rel-15 eMTC/NB-IoT”; and 3GPP TSG RAN WG1#88 R1-1703139 “Wake Up Radio for NR”. See 3GPP TSG RAN WG2#99 R2-1708285. The application and implementation of WUSs is not limited to these examples; e.g., 3GPP New Radio (NR) 5G technology may also employ WUSs, e.g., different types of WUS design may be used, e.g, WUS application is not limited to paging.

In the 3GPP NR, there is a flexibility in the Orthogonal Frequency Division Multiplex (OFDM) numerology. The OFDM numerology defines the subcarrier spacing (SCS). The SCS can change between 15 kHz up to 240 kHz, depending on the setting of the OFDM numerology. The flexibility has been introduced to fit different service types, since a wide SCS shortens the symbol time which thereby reduces the round-trip time on radio level. Further, the flexibility has been introduced to fit different deployment frequency ranges, since a larger carrier frequency typically means a larger SCS should be used.

This flexibility in the OFDM numerology also impacts the resource allocation and the occupied bandwidth for the NR system. A typical upper limit for the bandwidth per carrier 400 MHz and a lower limit of the bandwidth is 11 resource blocks. As the setting of the OFDM numerology is flexible, according to reference implementations, the bandwidth occupied by a signal in 3GPP NR is a function of the current value of the SCS. In NR, a UE may not need to monitor the whole channel bandwidth. It can be configured with maximum 4 bandwidth parts (BWP) in which 1 BWP as an active BWP. Each BWP has a specific OFDM numerology (i.e. SCS).

It has been found that an adaptive OFDM numerology can impact the transmission of a WUS. For example, typically, according to the adaptive OFDM numerology A WUS occupies different bandwidths depending on the current value of the SCS. Such variations in occupied bandwidth may be disadvantageous in relation to the target of achieving low energy cost in the UE for listening to a WUS signal.

### SUMMARY

Accordingly, there is a need for advanced techniques of transmitting a WUS, in particular in view of an adaptive OFDM numerology having multiple possible settings.

This need is met by the features of the independent claims. The features of the dependent claims define embodiments.

A method of operating an access node of a communication network includes determining a count of one or more subcarriers of a carrier. The count is determined depending on a setting of an adaptive modulation numerology of the carrier. The method also includes transmitting a wake-up signal to a wireless communication device on the one or more subcarriers.

A computer program or a computer-program product includes program code. The program code can be executed by at least one processor. Executing the program code causes the at least one processor to perform a method of operating an access node of a communication network. The method includes determining a count of one or more subcarriers of a carrier. The count is determined depending on a setting of an adaptive modulation numerology of the carrier. The method also includes transmitting a wake-up signal to a wireless communication device on the one or more subcarriers.

An access node of a communication network includes control circuitry configured to determine a count of one or more subcarriers of a carrier depending on a setting of an adaptive modulation numerology of the carrier. The control circuitry is also configured to transmit a wake-up signal to a wireless communication device on the one or more subcarriers.

A method of operating a wireless communication device includes receiving a wake-up signal on a first count of one or more subcarriers of a carrier in a first setting of an adaptive modulation numerology of the carrier. The first count of the one or more subcarriers defines a first bandwidth for the wake-up signal. The method also includes receiving the wake-up signal on a second count of the one or more subcarriers of the carrier in a second setting of the adaptive modulation numerology of the carrier. The second count of the one or more subcarriers defines a second bandwidth for the wake-up signal. The second count is different from the first count. The first bandwidth is within a range of 80% to 120% of the second bandwidth.

A computer program or a computer-program product includes program code. The program code can be executed by at least one processor. Executing the program code causes the at least one processor to perform a method of operating a wireless communication device. The method includes receiving a wake-up signal on a first count of one or more subcarriers of a carrier in a first setting of an adaptive modulation numerology of the carrier. The first count of the one or more subcarriers defines a first bandwidth for the wake-up signal. The method also includes receiving the wake-up signal on a second count of the one or more subcarriers of the carrier in a second setting of the adaptive modulation numerology of the carrier. The second count of the one or more subcarriers defines a second bandwidth for the wake-up signal. The second count is different from the first count. The first bandwidth is within a range of 80% to 120% of the second bandwidth.

A wireless communication device includes control circuitry. The control circuitry is configured to receive a wake-up signal on a first count of one or more subcarriers of a carrier in a first setting of an adaptive modulation numerology of the carrier, the first count of the one or more subcarriers defining a first bandwidth for the wake-up signal. The control circuitry is also configured to receive the wake-up signal on a second count of the one or more subcarriers of the carrier in a second setting of the adaptive modulation numerology of the carrier, the second count of the one or more subcarriers defining a second bandwidth for the wake-up signal, the second count being different from the first count. The first bandwidth is within a range of 80% to 120% of the second bandwidth.

A method of operating a wireless communication device includes receiving a wake-up signal on a predefined frequency band of a carrier having an adaptive modulation numerology. The method also includes, upon receiving the wake-up signal: receiving downlink control information indicative of a setting of the adaptive modulation numerology. The method further includes receiving a signal based on the setting of the adaptive modulation numerology.

A computer program or a computer-program product includes program code. The program code can be executed by at least one processor. Executing the program code causes the at least one processor to perform a method of operating a wireless communication device. The method includes receiving a wake-up signal on a predefined frequency band of a carrier having an adaptive modulation numerology. The method also includes, upon receiving the wake-up signal: receiving downlink control information indicative of a setting of the adaptive modulation numerology. The method further includes receiving a signal based on the setting of the adaptive modulation numerology.

A wireless communication device includes control circuitry. The control circuitry is configured to receive a wake-up signal on a predefined frequency band of a carrier having an adaptive modulation numerology; and upon receiving the wake-up signal: to receive downlink control information indicative of a setting of the adaptive modulation numerology; and to receive a signal based on the setting of the adaptive modulation numerology.

It is to be understood that the features mentioned above and those yet to be explained below may be used not only in the respective combinations indicated, but also in other combinations or in isolation without departing from the scope of the invention.

### BRIEF DESCRIPTION OF THE DRAWINGS

FIG. 1 schematically illustrates a cellular network according to various examples.

FIG. 2 schematically illustrates multiple channels implemented on a wireless link of the cellular network according to various examples.

FIG. 3 schematically illustrates multiple bandwidth parts implemented on the wireless link of the cellular network according to various examples.

FIG. 4 schematically illustrates subcarriers according to OFDM modulation on a carrier of the wireless link of the cellular network, and further illustrates on off keying on the wireless link of the cellular network according to various examples.

FIG. 5 schematically illustrates various modes according to which a UE can operate according to various examples.

FIG. 6 schematically illustrates a base station of a radio access network of the cellular network according to various examples.

FIG. 7 schematically illustrates a UE connectable to the cellular network according to various examples.

FIG. 8 schematically illustrates a main receiver and a low-power receiver of the UE according to various examples.

FIG. 9 schematically illustrates a main receiver and a low-power receiver of the UE according to various examples.

FIG. 10 is a flowchart of a method according to various examples, where in FIG. 10 illustrates aspects with respect to signal design of the WUS according to various examples.

FIG. 11 schematically illustrates a transmitter for a WUS according to various examples.

FIG. 12 illustrates details of the transmitter of FIG. 11 according to various examples.

FIG. 13 schematically illustrates a WUS according to various examples.

FIG. 14 schematically illustrates a receiver of the UE configured to receive a WUS according to various examples.

FIG. 15 schematically illustrates a receiver of the UE configured to receive a WUS according to various examples.

FIG. 16 is a signaling diagram of communication between the UE and the base station according to various examples.

FIG. 17 is a flowchart of a method according to various examples.

FIG. 18 illustrates reference implementations of a constant count of one or more subcarriers for transmission of a WUS.

FIG. 19 schematically illustrates a variable count of one or more subcarriers for transmission of a WUS according to various examples.

FIG. 20 is a flowchart of a method according to various examples.

### DETAILED DESCRIPTION OF EMBODIMENTS

Some examples of the present disclosure generally provide for a plurality of circuits or other electrical devices. All references to the circuits and other electrical devices and the functionality provided by each are not intended to be limited to encompassing only what is illustrated and described herein. While particular labels may be assigned to the various circuits or other electrical devices disclosed, such labels are not intended to limit the scope of operation for the circuits and the other electrical devices. Such circuits and other electrical devices may be combined with each other and/or separated in any manner based on the particular type of electrical implementation that is desired. It is recognized that any circuit or other electrical device disclosed herein may include any number of microcontrollers, a graphics processor unit (GPU), integrated circuits, memory devices (e.g., FLASH, random access memory (RAM), read only memory (ROM), electrically programmable read only memory (EPROM), electrically erasable programmable read only memory (EEPROM), or other suitable variants thereof), and software which co-act with one another to perform operation(s) disclosed herein. In addition, any one or more of the electrical devices may be configured to execute a program code that is embodied in a non-transitory computer readable medium programmed to perform any number of the functions as disclosed.

In the following, embodiments of the invention will be described in detail with reference to the accompanying drawings. It is to be understood that the following description of embodiments is not to be taken in a limiting sense. The scope of the invention is not intended to be limited by the embodiments described hereinafter or by the drawings, which are taken to be illustrative only.

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

Hereinafter, WUS functionality is described. The WUS functionality enables a UE to transition a main receiver (MRX) from a normal state into a shut-down state or a low-power state, e.g., for power saving purposes. Then, a wake-up receiver (WURX) or the MRX in the low-power state can be used to detect a WUS.

Typically, a modulation scheme of the WUS is comparably simple. A simple waveform results in a WUS that may be detected with a lower processing complexity at the receiver, if compared to other signals such as payload data or Layer 3 control data. The waveform may be detectable using time-domain processing. Synchronization (e.g. in time domain) between a transmitter and a receiver may not be required or can be coarse. Generally, detection of the WUS can require less complexity at the WURX or the MRX in the low-power state if compared to the normal operation of the MRX. At the same time, the power consumption of the WURX or the MRX in the low-power state can be significantly smaller than the power consumption of the MRX in the normal state. Hardware-wise, the MRX and WURX may share all, parts of or no components with each other. Therefore, by means of the WUS, the power consumption at the UE can be significantly reduced.

In further detail, the WUS may help to avoid blind decoding of a control channel. Since typically such blind decoding is comparably energy inefficient, thereby, power consumption can be reduced by using WUSs. This option to avoid blind decoding is explained in greater detail hereinafter: For example, in the reference scenario without WUSs, during POs, the UE is expected to blind decode the MPDCCH for MTC or the PDCCH for 3GPP LTE 4G. The blind decoding during the POs is for a paging radio network temporary identifier (P-RNTI) as paging identity, typically transmitted as a so-called paging indicator. If presence of a paging indicator including the P-RNTI is detected, the UE continues to decode a subsequent physical downlink (DL) data shared channel (PDSCH) for a paging message. The blind decoding is comparably energy inefficient and by means of the WUS can be conditionally triggered.

Various techniques described herein are based on the finding that an adaptive OFDM numerology can impact the UE operation for receiving the WUS. For example, according to reference implementations, a change in the setting of the OFDM numerology can lead to a change in the SCS. Then, according to the reference implementations, one and the same signal occupies a larger or smaller bandwidth, depending on the SCS. This means that a receiver needs to adapt the receiver bandwidth for the detection and demodulation (receiving) of the signal, in accordance with the varying setting of the OFDM numerology. One such adaption of the receiver would be that the receiver should be able to detect the WUS for any allowed OFDM numerology, meaning that the hardware for the receiver bandwidth must be constructed based on the largest (worst case) bandwidth possible for the WUS. This would mean that for any other OFDM numerology the receiver has an unnecessary large hardware complexity. Further, a dynamic adjustment of the receiver to accommodate smaller bandwidths of the WUS will also be required. It has been found that such adjustment of the receiver bandwidth can be unsuitable or difficult to implement for the WURX or the MRX in the low-power state. This can have multiple reasons. Firstly, hardware complexity may be increased—which may be generally unfavorable for low-complexity WURXs or a MRX in a low-power state. For example, a bandwidth-adaptive filter element in analog domain may be required. Secondly, bandwidth-adaptive filter elements required to implement a variable receiver bandwidth may have a comparably large power consumption. On the other hand, there may be a desire to generally reduce the power consumption at the UE as much as possible, while monitoring for WUSs. Thus, such reference implementations face certain restrictions and drawbacks. The various examples described herein mitigate and overcome such restrictions and drawbacks.

According to various examples described herein, a mapping of a WUS to one or more subcarriers of a carrier can be flexibly determined, depending on the current setting of the OFDM numerology. In particular, the mapping can be characterized by a count of subcarriers and/or a frequency position of the subcarriers. Thus, as a general rule, the count of subcarriers and/or the frequency position of subcarriers may be flexibly determined, depending on the current setting of the OFDM numerology.

Various concepts of flexibly adjusting a mapping of the WUS to the one or more subcarriers are described hereinafter with respect to an example implementation in which, in particular, the count of the one or more subcarriers is determined. However, as a general rule, it would be possible that — alternatively or additionally to determining the count of the one or more subcarriers — one or more other properties of the mapping of the WUS to the one or more subcarriers are determined. To give a few examples: it would be possible to determine a frequency position of the one or more subcarriers, a power level of the one or more subcarriers, and/or an identification index of the one or more subcarriers.

As a general rule, the current setting of the OFDM numerology can define various properties including the SCS. Thus, different settings of the OFDM numerology can be associated with different SCSs.

According to various examples, the WUS can be flexibly mapped to a variable count of subcarriers, depending on the current setting of the OFDM numerology, e.g., depending on the SCS. Thereby, the bandwidth occupied by the WUS (WUS BW) can remain essentially constant, even in view of a changing setting of the OFDM numerology such as a changing SCS. In other words, it is possible to scale the number of subcarriers used for the transmission of the WUS with the SCS being used, so that the required receive bandwidth at the WURX or the MRX in the low-power state can remain constant or at least vary only slightly. Thereby, low-power, low complexity WURXs or MRXs in a low-power state can be facilitated.

As a general rule, it would be possible that the count of the one or more subcarriers is determined using an inverse scaling factor. I.e., the inverse scaling factor can define the dependency between (i) a current setting of the adaptive OFDM numerology such as a current SCS, and (ii) the count of the one or more subcarriers used for the transmission of the WUS. In detail, this means that a larger (smaller) SCS would result in a smaller (larger) count of the one or more subcarriers. Thereby, the WUS BW can remain essentially constant, in particular if a linear scaling factor is used.

In some examples, the concepts of determining the count of the one or more subcarriers depending on a current setting of the OFDM numerology may be combined with concepts of bandwidth parts (BWPs) and, in particular, BWP adaptation. According to the 3GPP NR, BWP adaptation allows to adjust the assigned BWP for a given UE. This adjustment can be done dynamically, e.g., depending on the traffic and data payload. This sometimes can lead to power saving at the UE. By means of BWP adaptation, the UE can switch to different BWPs depending on the payload size and traffic, for power saving purposes. For example, the UE can use a narrow BWP for monitoring control channels and only open the full bandwidth of the carrier when a large amount of data is scheduled. Upon completion of the data transfer requiring the wider bandwidth, the UE can revert to the original BWP. According to some implementations, up to 4 BWPs can be configured when the UE is in connected mode in which 1 is an active BWP and only one BWP, i.e., the default BWP is allowed when the UE is in idle mode. However, according to reference implementations, the bandwidth can never become smaller than the default BWP or the one needed to receive the synchronization signal. For example, the receive BW can be limited accordingly. A concept of sub-BWPs uses hierarchies between multiple BWPs. Various techniques are based on the finding that the above-described configuration of the BWP according to reference implementations is sub-optimal if the purpose is to allow power saving using WURX or a MRX in a low-power state. This is because, according to reference implementations, the BWP is configured to carry both control signals and/or payload data. Thus, the bandwidth of the BWP may be relatively wide. Therefore, it can be helpful to configure a dedicated BWP to accommodate WUSs.

According to various examples, it would be possible that the count of the one or more subcarriers is determined also depending on BWPs or sub-BWPs defined on the carrier. Alternatively or additionally, it would also be possible to configure the BWPs or sub-BWPs depending on the determined count of the one or more subcarriers. For example, a BWP or sub-BWP can be employed which is statically or dynamically reserved for the transmission of WUSs to one or more UEs.

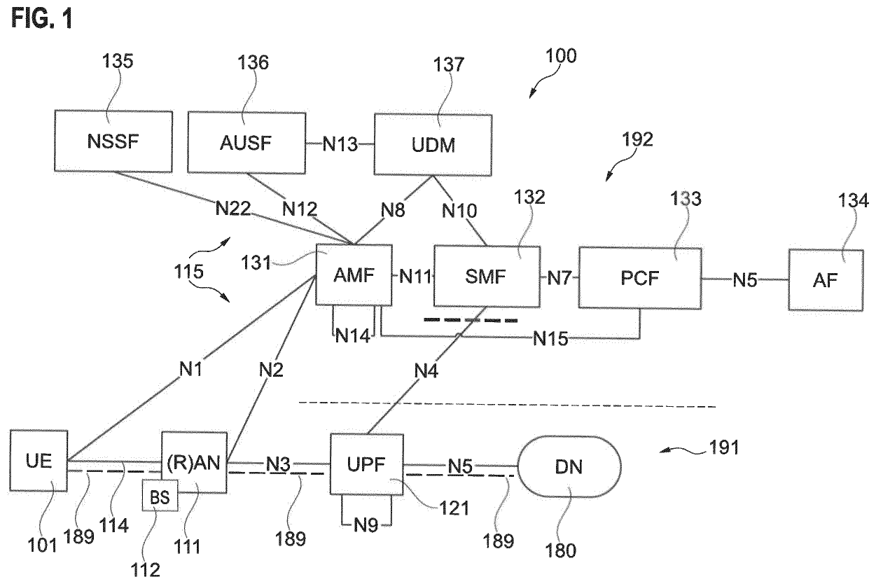

FIG. 1 schematically illustrates a cellular network 100. The example of FIG. 1 illustrates the network 100 according to the 3GPP 5G architecture. Details of the 3GPP 5G architecture are described in 3GPP TS 23.501, version 1.3.0 (2017-09). While FIG. 1 and further parts of the following description illustrate techniques in the 3GPP 5G framework of a cellular network, similar techniques may be readily applied to other communication networks. Examples include e.g., an IEEE Wi-Fi technology.

In the scenario of FIG. 1, a UE 101 is connectable to the cellular network 100. For example, the UE 101 may be one of the following: a cellular phone; a smart phone; and IOT device; a MTC device; a sensor; an actuator; etc.

The UE 101 is connectable to the network 100 via a radio access network (RAN) 111, typically formed by one or more base stations (BSs) 112 (only a single BS 112 is illustrated in FIG. 1 for sake of simplicity). A wireless link 114 is established between the RAN 111—specifically between one or more of the BSs 112 of the RAN 111—and the UE 101. The wireless link 114 is defined by one or more OFDM carriers.

The RAN 111 is connected to a core network (CN) 115. The CN 115 includes a user plane (UP) 191 and a control plane (CP) 192. Application data is typically routed via the UP 191. For this, there is provided a UP function (UPF) 121. The UPF 121 may implement router functionality. Application data may pass through one or more UPFs 121. In the scenario of FIG. 1, the UPF 121 acts as a gateway towards a data network 180, e.g., the Internet or a Local Area Network. Application data can be communicated between the UE 101 and one or more servers on the data network 180.

The network 100 also includes an Access and Mobility Management Function (AMF) 131; a Session Management Function (SMF) 132; a Policy Control Function (PCF) 133; an Application Function (AF) 134; a Network Slice Selection Function (NSSF) 134; an Authentication Server Function (AUSF) 136; and a Unified Data Management (UDM) 137. FIG. 1 also illustrates the protocol reference points N1-N22 between these nodes.

The AMF 131 provides one or more of the following functionalities: registration management; NAS termination; connection management; reachability management; mobility management; access authentication; and access authorization. For example, the AMF 131 controls CN-initiated paging of the UEs 101 if the respective UE 101 operates in Radio Resource Control (RRC) idle mode. The AMF 131 may keep track of the timing of a discontinuous reception (DRX) cycle of the UE 101. The AMF 131 may trigger transmission of WUSs and/or of paging indicators and/or paging messages to the UE 101; this may be time-aligned with POs that are defined in connection with on durations of the DRX cycle.

A data connection 189 is established by the AMF 131 if the respective UE 101 operates in a connected mode. To keep track of the current mode of the UEs 101, the AMF 131 sets the UE 101 to ECM connected or ECM idle. During ECM connected, a non-access stratum (NAS) connection is maintained between the UE 101 and the AMF 131. The NAS connection implements an example of a mobility control connection. The NAS connection may be set up in response to paging of the UE 101.

The SMF 132 provides one or more of the following functionalities: session management including session establishment, modify and release, including bearers set up of UP bearers between the RAN 111 and the UPF 121; selection and control of UPFs; configuring of traffic steering; roaming functionality; termination of at least parts of NAS messages; etc. As such, the AMF 131 and the SMF 132 both implement CP mobility management needed to support a moving UE.

The data connection 189 is established between the UE 101 via the RAN 111 and the data plane 191 of the CN 115 and towards the DN 180. For example, a connection with the Internet or another packet data network can be established. To establish the data connection 189, it is possible that the respective UE 101 performs a random access (RACH) procedure, e.g., in response to reception of a paging indicator or paging message and, optionally, a preceding WUS. A server of the DN 180 may host a service for which payload data is communicated via the data connection 189. The data connection 189 may include one or more bearers such as a dedicated bearer or a default bearer. The data connection 189 may be defined on the RRC layer, e.g., generally Layer 3 of the OSI model of Layer 2.

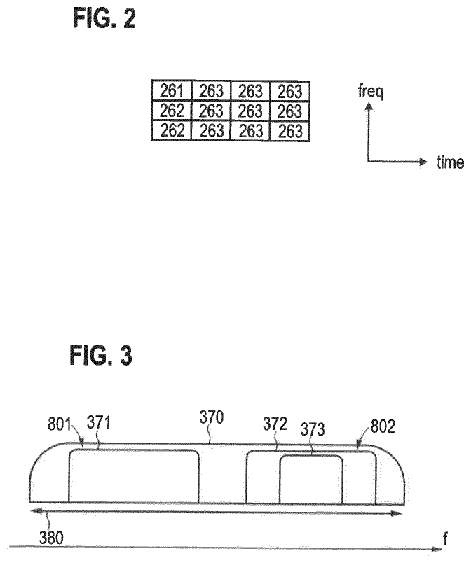

FIG. 2 illustrates aspects with respect to channels 261-263 implemented on the wireless link 114. The wireless link 114 implements a plurality of channels 261-263. The resources of the channels 261-263 are offset from each other, e.g., in frequency domain and/or time domain. The resources may be defined in a time-frequency grid defined by the symbols and subcarriers of the OFDM of the carrier.

A first channel 261 may carry WUSs. The WUSs enable the network 100—e.g., the AMF 131—to wake-up the UE 101, e.g., at or prior to a PO.

A second channel 262 may carry control information related to the subsequent channel (e.g. paging indicators) which enable the network 100—e.g., the AMF 131—to page the UE 101 during a PO. Typically, the paging indicators are communicated on PDCCH.

As will be appreciated from the above, the WUSs and the paging indicators may be different from each other in that they are transmitted on different channels 261, 262. Different resources may be allocated to the different channels 261-263.

Further, a third channel 263 is associated with a payload messages carrying higher-layer user-plane data packets associated with a given service implemented by the UE 101 and the BS 112 (payload channel 263). User-data messages may be transmitted via the payload channel 263. Alternatively, control messages may be transmitted via the channel 263, e.g., a paging message.

FIG. 3 illustrates aspects in connection with a carrier 370 of the wireless link 114. FIG. 3 schematically illustrates a bandwidth 380 of the carrier 370. For example, the carrier 370 can operate according to OFDM and can include multiple subcarriers (not illustrated in FIG. 3).

FIG. 3 further illustrates aspects of BWPs 371-372. The BWPs 371-372, respectively, occupy an associated subfraction of the overall bandwidth 380. The BWP 372 includes a sub-BWP 373, having a smaller BW and being associated with the BWP 372.

For example, scheduling data transmission can be relatively defined with respect to the respective BWP 371-373. Each BWP 371-373 can be defined as a subset of continuous and contiguous common physical resource blocks (PRBs), each PRB defining a set of resources in the time-frequency grid. Thereby, scheduling information can be compressed. Further, a receiver of the UE 101, if configured to monitor, e.g., the BWP 371, can limit its receive bandwidth correspondingly. As a general rule, each BWP 371-372 and sub-BWP 373 each can have a unique OFDM numerology. As illustrated in FIG. 3, the BWP 371 implements a first numerology 801; while the BWP 372 and the sub-BWP 373 implement a second numerology 802. By switching between different BWPs the wireless system can dynamically switch between different frequency bandwidths being utilized for communicating with the different UEs or different channels, i.e., control channel or data channel. Also, by the use of different numerologies in different BWPs different QoS levels may be achieved due to the numerology relation to the OFDM symbol length.

As a general rule, there are various parameters conceivable that are affected by the respective setting of the OFDM numerology 801, 802. To give a few examples, the SCS of subcarriers of the carrier 370 can vary. Also, the number of time slots per subframe can depend on the setting of the OFDM numerology 801, 802. For example, the number of OFDM symbols per time slot can thereby vary along with the change of the settings of the OFDM numerology 801, 802. The cyclic prefix length can vary with the change of SCS. In a further example, the time division duplex (TDD) partitioning can vary, depending on the setting of the numerology 801, 802.

Table 1 schematically illustrates how the setting of the numerology impacts the SCS in some examples, the number of time slot per subframe and the duration of each time slot.

TABLE 1
various OFDM numerology settings

| Numerology | | | # slots per | |
|---|---|---|---|---|
| setting | SCS | | subframe | Slot length |
| 0 | 15 | kHz | 1 | 1 ms/2¹ = 1 ms |
| 1 | 30 | kHz | 2 | 1 ms/2² = 500 us |
| 2 | 60 | kHz | 4 | 1 ms/2⁴ = 250 us |
| 3 | 120 | kHz | 8 | 1 ms/2⁸ = 125 μs |

As a general rule, while various aspects regarding variable settings of an adaptive OFDM numerology have been explained above in connection with BWPs, it would be generally possible that an OFDM carrier implements an adaptive OFDM numerology having variable settings without the use of BWPs.

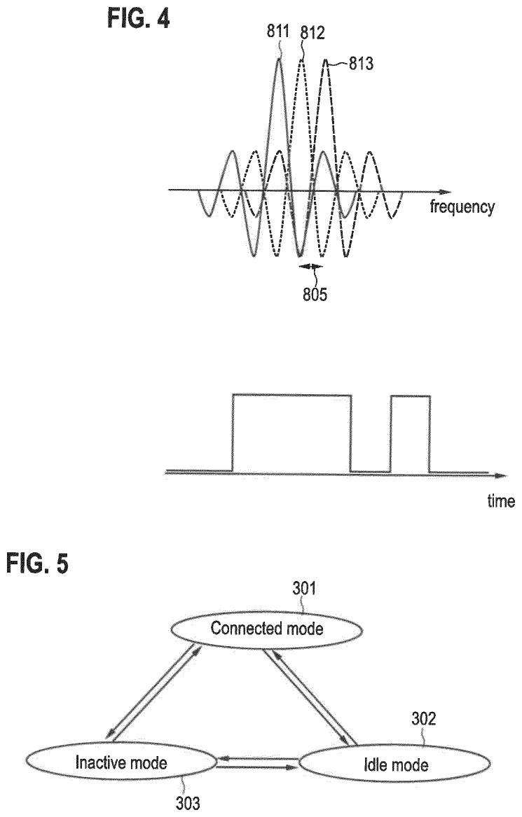

FIG. 4 illustrates aspects with respect to communicating on the wireless link 114. Specifically, FIG. 4 illustrates aspects with respect to modulation of signals to communicated on the wireless link 114.

Specifically, FIG. 4, upper part, illustrates multiple subcarriers 811-813 in frequency domain used for OFDM modulation. Different subcarriers 811-813 are orthogonal with respect to each other and thus can each encode specific information with reduced interference. As a general rule, OFDM modulation may employ a variable count of subcarriers 811-813, e.g., between twenty and two thousand subcarriers. The count of subcarriers can carry as a setting of the OFDM numerology 801, 802. FIG. 4 also illustrates the SCS 805 of the current setting of the OFDM numerology 801, 802.

FIG. 4, lower part, illustrates a signal waveform that is defined in accordance with an On-Off-Keying (OOK) modulation. To demodulate data encoded by a carrier or subcarrier using OOK, non-coherent decoding may be employed. The transmitter and receiver may require less precise or no synchronization in frequency and time.

Various techniques are based on the finding that, in a WURX or a MRX in a low-power state, simple non-coherent modulation schemes, such as OOK or Frequency Shift Keying (FSK), are often used for the signal transmission, since it allows low-power low-complex front-end architecture.

FIG. 5 illustrates aspects with respect to different modes 301-302 in which the UE 101 can operate. Example implementations of the operational modes 301-302 are described, e.g., in 3GPP TS 38.300, e.g., version 15.0.0.

During a connected mode 301, the data connection 189 is set up. For example, a default bearer and optionally one or more dedicated bearers may be set up between the UE 101 and the cellular network 100. A wireless interface of the UE 101 may persistently operate in an active state, or may implement a DRX cycle.

To achieve a power reduction, it is possible to implement the idle mode 302. When operating in the idle mode 302, the UE 101 is configured to monitor for WUSs, paging indicators and, optionally, paging messages in accordance with a timing of POs. The timing of the POs may be aligned with a DRX cycle in idle mode 302. This may help to further reduce the power consumption—e.g., if compared to the connected mode 301. In the idle mode 302, the data connection 189 is not maintained, but released.

FIG. 5 also illustrates an inactive mode 303. The inactive mode 303 is associated with a suspended data connection 189, e.g., after an inactivity timer expiry. The data connection 189 can be quickly resumed by transitioning to connected mode 301. For example, the AMF 131 may not be involved using NAS control signaling to transition from the connected mode 301 to the inactive mode 303; thus, the connected mode 301 vs. inactive mode 303 may be transparent to the AMF 131.

As a general rule, WUSs may be employed in connected mode 301 and/or idle mode 302 and/or the inactive mode 303. For example, in connected mode 301, a UE context for the data connection 189 may be buffered and may be re-loaded upon communicating the WUS. In connected mode, instead of constantly monitoring the control channel, the UE can be configured to monitor the WUS prior to any potential subsequent control channel.

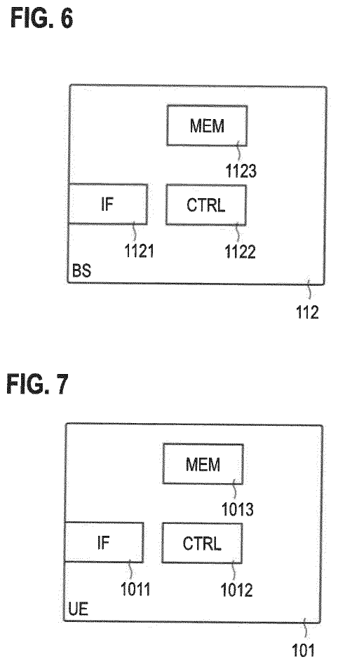

FIG. 6 schematically illustrates the BS 112. The BS 112 includes an interface 1121. For example, the interface 1121 may include an analog front end and a digital front end. The interface 1121 can support multiple signal designs, e.g., different modulation schemes, coding schemes, modulation numerologies, and/or multiplexing schemes, etc. The BS 112 further includes control circuitry 1122, e.g., implemented by means of one or more processors and software. For example, program code to be executed by the control circuitry 1122 may be stored in a non-volatile memory 1123. In the various examples disclosed herein, various functionality may be implemented by the control circuitry 1122, e.g.: receiving WUS-related capabilities from UEs; determining at least one WUS, based on the WUS-related capabilities; transmitting a WUS-related configuration to the UEs; transmitting and/or triggering transmission of the at least one WUS; determining a mapping of a WUS to one or more subcarriers 811-813, e.g. depending on the setting of the modulation numerology; configuring BWPs; supporting adaptive BWPs; etc.

Generally, also other nodes of the network 100 may be configured in a manner comparable to the configuration of the BS 112, e.g., the AMF 131 or the SMF 132.

FIG. 7 schematically illustrates the UE 101. The UE 101 includes an interface 1011. For example, the interface 1011 may include an analog front end and a digital front end. In some examples, the interface 1011 may include an MRX and a WURX (not illustrated in FIG. 7). Each one of the MRX and the WURX may include an analog front end and a digital front end, respectively. The MRX and the WURX can support different signal designs. For example, the WURX may typically support simpler signal designs that the MRX. For example, the WURX may only support simpler modulations, modulation schemes having lower constellations, etc. The WURX may, e.g., not support OFDM demodulation. The WURX may support time-domain processing; but may not support synchronized demodulation. The UE 101 further includes control circuitry 1012, e.g., implemented by means of one or more processors and software. The control circuitry 1012 may also be at least partly implemented in hardware. For example, program code to be executed by the control circuitry 1012 may be stored in a non-volatile memory 1013. In the various examples disclosed herein, various functionality may be implemented by the control circuitry 1012, e.g.: transmitting a WUS-related capability to a network; receiving a WUS-related configuration; receiving a WUS in accordance with the WUS-related configuration; etc.

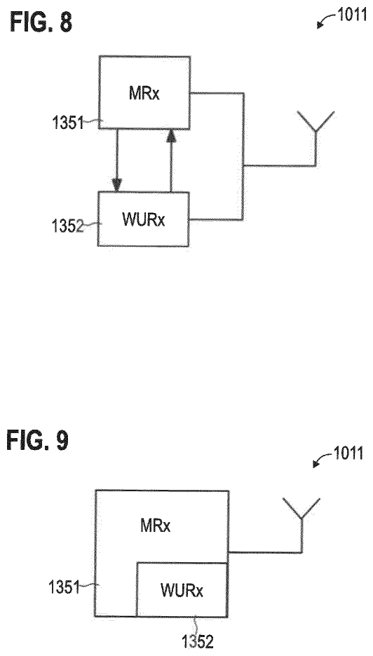

FIG. 8 illustrates details with respect to the interface 1011 of the UE 101. In particular, FIG. 8 illustrates aspects with respect to a MRX 1351 and a WURX 1352. In FIG. 8, the MRX 1351 and the WURX 1352 are implemented as separate entities. For example, they may be implemented on different chips. For example, they may be implemented in different housings. For example, they may not share a common power supply.

The scenario FIG. 8 may enable switching off some or all components of the MRX 1351 when operating the MRX in a shut-down state. In the various examples described herein, it may then be possible to receive WUSs using the WURX 1352. Also, the WURX 1352 may be switched between an inactive state and an active state, e.g., according to a DRX cycle. For example, the WURX 1352 may be transitioned to an active state at a given time offset prior to a PO or a DRX-on in connected mode.

For example, if the MRX 1351 is switched on, the WURX 1352 may be switched off, and vice-versa. As such, the MRX 1351 and the WURX 1352 may be inter-related in operation (indicated by the arrows in FIG. 8).

FIG. 9 illustrates details with respect to the interface 1011 of the UE 101. In particular, FIG. 9 illustrates aspects with respect to the MRX 1351 and the WURX 1352. In FIG. 9, the MRX 1351 and the WURX 1352 are implemented as a common entity. For example, they may be implemented on the common chip, i.e., integrated on a common die. For example, they may be implemented in a common housing. For example, they may share a common power supply.

The scenario FIG. 9 may enable a particular low latency for transitioning between reception—e.g., of a WUS—by the WURX 1352 and reception by the MRX 1351.

While in FIGS. 8 and 9 a scenario is illustrated where the MRX 1351 and the WURX 1352 share a common antenna, in other examples, it would be also possible that the interface 1011 includes dedicated antennas for the MRX 1351 and the WURX 1352.

While in the examples of FIGS. 8 and 9 scenarios are illustrated where there is a dedicated WURX 1352, in other examples there may be no WURX. Instead, the WUS may be received by the MRX 1351 in a low-power state. For example, the MRX 1351 may not be fit to receive ordinary data—e.g., OFDM modulated data—other than the WUS in the low-power state. Then, in response to receiving the WUS, the MRX 1351 may transition into a high-power state in which it is fit to receive the ordinary data, e.g., on channel 263, etc.

Thus, more generally speaking, there is a wide variety of options available for implementing the receiver hardware that facilitates reception of the WUS.

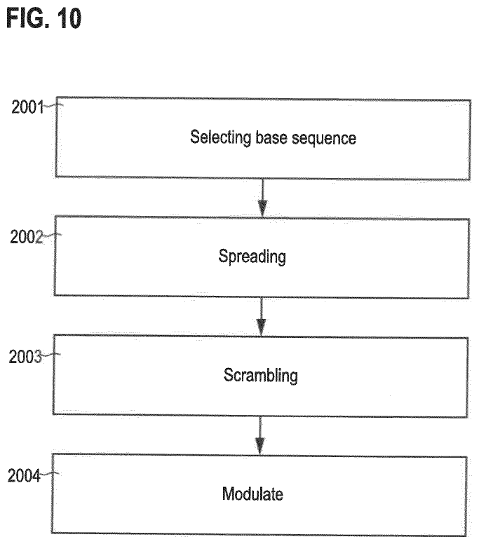

FIG. 10 is a flowchart of a method according to various examples. FIG. 10 illustrates aspects with respect to constructing or generating the WUS. FIG. 10 schematically illustrates various aspects with respect to signal design of a WUS.

For example, the method according to FIG. 10 could be executed by the control circuitry 1122 of the BS 112. In the various examples described herein, it may be possible to construct the WUSs according to the method of FIG. 10. As a general rule, there may be a set of WUSs available, each WUS of the set of WUS having one or more specific values of the signal design parameters as explained below in connection with the blocks 2001-2003.

First, a certain base sequence is selected, 2001. For example the base sequence may be a randomly generated set of bits. For example the base sequence may be unique for a UE or a group of UEs. For example, the base sequence may be unique for a cell of the cellular network 100. For example, the base sequence may be selected from the group including: a Zadoff-Chu sequence; a sequence selected from a set of orthogonal or quasi-orthogonal sequences; and a Walsh-Hadamard sequence. For example, selecting the particular base sequence or type of base sequence can be subject to signal design of the WUS. For example, setting the sequence length of the base sequence of the WUS can be subject to signal design of the WUS. Selecting the base sequence can be subject to signal design of the WUS.

Next, spreading may be applied to the base sequence, 2002. When spreading a bit sequence, the incoming bit sequence is spread/multiplied with a spreading sequence. This increases the length of the incoming bit sequence by a spreading factor K. The resulting bit sequence can be of the same length as the incoming bit sequence times the spreading factor. Details of the spreading can be set by a spreading parameter. For example, the spreading parameter may specify the spreading sequence, e.g., a length of the spreading sequence or individual bits of the spreading sequence. Setting the spreading parameter can be subject to signal design of the WUS.

Then, scrambling may be applied to the spread base sequence, 2003. Scrambling may relate to inter-changing or transposing a sequence of the bits of the incoming bit sequence according to one or more rules. Scrambling provides for randomization of the incoming bit sequence. Based on a scrambling code, the original bit sequence can be reproduced at the receiver. Details of the scrambling can be set by a scrambling parameter. For example, the scrambling parameter can identify the one or more rules. For example, the scrambling parameter can relate to the scrambling code. Setting the scrambling parameter can be subject to signal design of the WUS.

In some examples, it may be possible to additionally add a checksum to the WUS. Adding a checksum may be subject to signal design of the WUS. For example, a checksum protection parameter may set whether to include or to not include the checksum. For example, the checksum protection parameter may set a length of the checksum. For example, the checksum protection parameter may set a type of the checksum, e.g., according to different error-correction algorithms, etc. The checksum may provide for joint error detection and, optionally, correction capability across the entire length of the WUS.

In some examples, it may be possible to add a preamble to the WUS. The preamble may include a sequence of preamble bits. For example, the sequence of preamble bits may have a specific length. The sequence of preamble bits may enable robust identification of the WUS, e.g., even in presence of burst errors, channel delay spread, etc. Presence of the preamble, length of the preamble, and/or type of the preamble sequence, etc. can be properties that can subject to the signal design of the WUS.

Finally, at block 2004, the bit sequence obtained from blocks 2001-2003 is modulated in accordance with a modulation scheme, e.g., OOK or FSK, OFDM etc. This corresponds to analog processing. Different modulation schemes can be represented by different constellations. Also, within a given modulation scheme, it is sometimes possible to change the bit loading, i.e., increasing or decreasing the number of bits per symbol and, thereby, changing the modulation constellation. All such modulation-related parameters can be subject to the signal design of the WUS. Different WUSs can be associated with different modulation schemes and/or different modulation constellations.

As a general rule, such signal design as explained in connection with blocks 2001-2004 can be configured in accordance with respective values of signal design parameters. Depending on the implementation, there can be various such signal design parameters open for configuration, i.e., with variable values.

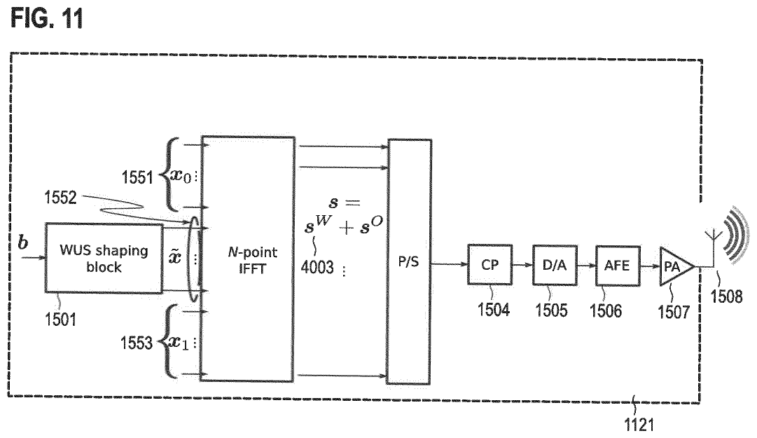

FIG. 11 illustrates aspects with respect to the wireless interface 1121 of the BS 112. FIG. 11 illustrates aspects with respect to transmitting the WUS 4003.

In FIG. 11 an OFDM-based, single carrier WUS 4003 that can be decoded by the WURX 1352 or the MRX 1361 in the low-power state is described. The WUS 4003 can be both orthogonal to the rest of the OFDM symbol and can be received by a non-coherent WURX or MRX in the low-power state that does not require tight synchronization. No energy-costly synchronization signal is needed for the WUS detection. Moreover, using the WUS 4003 according to FIG. 11, the receiver may not require information on a current SCS of the OFDM numerology 801, 802 of the carrier.

The interface 1121 includes a WUS signal-shaping block 1501; an IFFT block 1502; a parallel-to-serial block 1503; a cyclic prefix block 1504; a digital-to-analog converter 1505; an analog frontend 1506; and a power amplifier 1507. The interface 1121 is coupled to one or more antennas 1508.

A reference WUS waveform b is input to the WUS signal-shaping block 1501. As a general rule, the reference WUS waveform b can be defined in accordance with a noncoherent modulation scheme, e.g., OOK, Frequency-shift keying (FSK). Hence, information encoded by the reference WUS waveform b can be mapped to a constellation of a non-coherent modulation scheme.

Non-coherent modulation schemes do generally not require a receiver clock to be in-phase, i.e., synchronized with the transmitter, specifically, the carrier signal of the transmitter. In this case, modulation symbols (rather than bits, characters, or data packets) are asynchronously transferred.

As a general rule, the term “waveform” is used herein to the baseband representation of a signal—i.e., not modulated onto a respective carrier and subcarrier. For example, a waveform may be obtained by encoding a bit stream. Interleaving can be applied. Then, to obtain the waveform mapping onto the constellation of the respective modulation can be applied, e.g., a mapping onto the OOK constellation, etc.

The WUS signal-shaping block 1501 shapes the reference WUS waveform b. This shaping is done to facilitate, both, (i) OFDM modulation, as well as (ii) use of a non-coherent WURX or MRX in the low-power state at the receiver node (not illustrated in FIG. 11).

The reference WUS waveform b is shaped to obtain multiple WUS waveforms \tilde{x}. The various WUS waveforms \tilde{x} are associated with the WUS subcarriers reserved for the WUS channel 261. The multiple WUS waveforms \tilde{x} are input into respective channels 1552 of the IFFT block 1502.

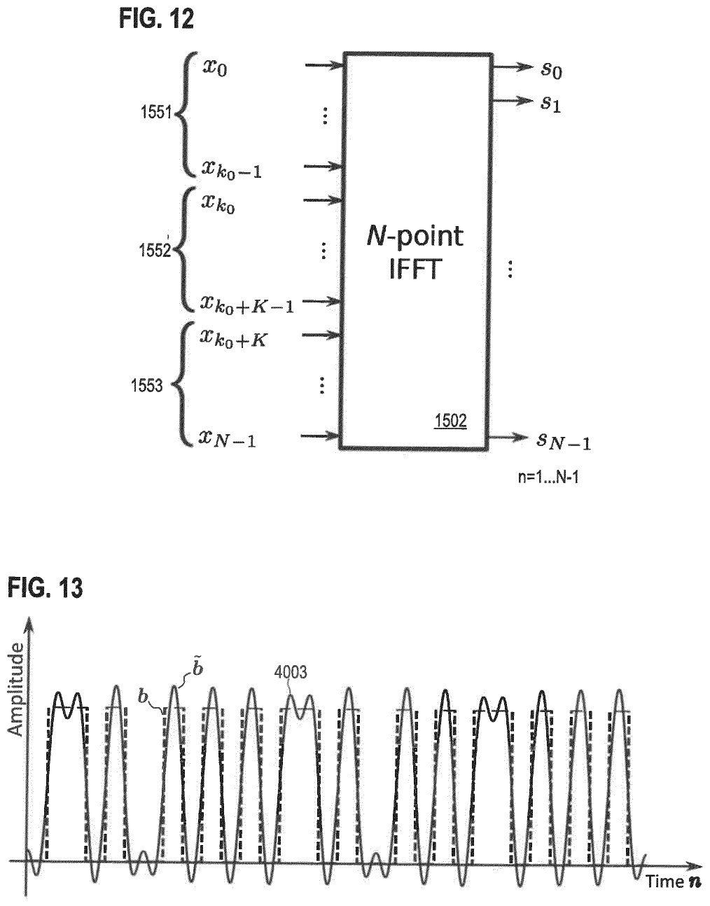

Generally, the IFFT block 1502 provides modulation of signal waveforms onto various subcarriers. The OFDM modulation facilitated by the IFFT block 1502 enables FDD: Further channels 1551, 1553 of the IFFT block 1502 are used to communicate on other channels 262, 263, e.g., with other UEs. A plurality of data signal waveforms x₀, x₁—associated with subcarriers different from the WUS subcarriers—are obtained. The data signal waveforms x₀, x₁ are defined in accordance with a coherent modulation scheme, e.g., QPSK, BPSK, or QAM. The data signal waveforms x₀, x₁ are then input to the channels 1551, 1553 of the IFFT block 1502 (also cf. FIG. 12, where details of the IFFT block 1502 are shown).

In accordance with FIGS. 11 and 12, a vector representation of the data input to the IFFT block 1502 is as follows:

$$x = [ \begin{matrix}{x}_{0} \\ ⋮ \\ {x}_{{k}_{0} - 1} \\ -- \\ {x}_{{k}_{0}} \\ ⋮ \\ {x}_{{k}_{0} + K - 1} \\ -- \\ {x}_{{k}_{0} + K} \\ ⋮ \\ {x}_{N - 1}\end{matrix} ] = [ \begin{matrix}{x}_{0} \\ -- \\ \tilde{x} \\ -- \\ {x}_{1}\end{matrix} ] \qquad ( 1 )$$

In Eq. (1),

$${x}_{0} = [ \begin{matrix}{x}_{0} \\ ⋮ \\ {x}_{{k}_{0} - 1}\end{matrix} ] \qquad ( 2 )$$

$${x}_{1} = [ \begin{matrix}{x}_{{k}_{0} + K} \\ ⋮ \\ {x}_{N - 1}\end{matrix} ]$$

denotes the data signal waveforms and

$$\tilde{x} = [ \begin{matrix}{x}_{0} \\ ⋮ \\ {x}_{{k}_{0} + K - 1}\end{matrix} ] \qquad ( 3 )$$

denotes the WUS waveform. K denotes the set of sub-carriers associated with the WUS waveform \tilde{x}, i.e., {k₀, . . . k₀+K−1}. The center sub-carrier of K is k_{c}.

The IFFT block 1502 transforms from frequency domain to time domain. An output of the IFFT block 1502 corresponds to a set of complex time-domain samples representing the OFDM subcarrier signals.

The operation of the IFFT block 1502 can be represented in time domain as follows:

$$\begin{matrix}{s}_{n} = \frac{1}{N} {\sum }_{k = 0}^{N - 1} {x}_{k} {e}^{j 2 π \begin{matrix}kn \\ N\end{matrix}} \\ = {\underbrace{\begin{matrix}1 \\ N\end{matrix} {\sum }_{k ∈ 𝒦} {x}_{k} {e}^{j 2 π \begin{matrix}kn \\ N\end{matrix}}}}_{On WUS subcarriers : {s}_{n}^{W}} + {\underbrace{\begin{matrix}1 \\ N\end{matrix} {\sum }_{k ∉ 𝒦} {x}_{k} {e}^{j 2 π \begin{matrix}kn \\ N\end{matrix}}}}_{On other subcarriers : {s}_{n}^{O}} \\ = {e}^{j 2 π \begin{matrix}{k}_{e} n \\ N\end{matrix}} {\underbrace{\begin{matrix}1 \\ N\end{matrix} {\sum }_{k ∈ 𝒦} {x}_{k} {e}^{j 2 π \begin{matrix}( k - {k}_{e} ) n \\ N\end{matrix}}}}_{Baseband WUS {\tilde{b}}_{n}} + \begin{matrix}1 \\ N\end{matrix} {\sum }_{k ∈ 𝒦} {x}_{k} {e}^{j 2 π \begin{matrix}kn \\ N\end{matrix}} \\ = {e}^{j 2 {π}_{N}^{{k}_{e} n}} {\tilde{b}}_{n} + {s}_{n}^{O} \\ = {s}_{n}^{W} + {s}_{n}^{O}\end{matrix} \qquad ( 4 )$$

The baseband representation of the WUS sₙ^{W} is denoted \tilde{b}ₙ. Here, “baseband” refers to the signal before modulation onto the sub-carriers. Here, n is the index of the various output channels of the IFFT block 1502.

The IFFT block can be described by a linear transformation function F; Eq. (4) can be re-written in matrix notation:

$$s = [ \begin{matrix}{s}_{0} \\ ⋮ \\ {s}_{N - 1}\end{matrix} ] = {IFFT}_{N} ( x ) = Fx = F [ \begin{matrix}0 \\ \tilde{x} \\ 0\end{matrix} ] + F [ \begin{matrix}{x}_{0} \\ 0 \\ {x}_{1}\end{matrix} ] = [ \begin{matrix}{s}_{0}^{W} \\ ⋮ \\ {s}_{N - 1}^{W}\end{matrix} ] + [ \begin{matrix}{s}_{0}^{O} \\ ⋮ \\ {s}_{N - 1}^{O}\end{matrix} ] = {s}^{W} + {s}^{O} \qquad ( 5 )$$

$$F = \frac{1}{N} [ \begin{matrix}1 & 1 & 1 & … & 1 \\ 1 & ω & {ω}^{2} & … & {ω}^{N - 1} \\ 1 & {ω}^{2} & {ω}^{4} & … & {ω}^{( N - 1 ) 2} \\ ⋮ & ⋮ & ⋮ & ⋱ & ⋮ \\ 1 & {ω}^{N - 1} & {ω}^{2 ( N - 1 )} & … & {ω}^{( N - 1 ) ( N - 1 )}\end{matrix} ] for ω = {e}^{j \frac{2 π}{N}}$$

In block 1503, the samples are clocked out to provide the OFDM symbol s of a certain duration. A guard interval—implemented by a cyclic prefix—is added by the CP block 1504, which increases the length of the OFDM symbol. Hence, blocks 1502, 1503, 1504 implement an OFDM modulator as they output a baseband OFDM symbol of a certain duration.

Then, the blocks 1505-1507 are controlled to transform the OFDM symbol into analog domain, modulate it onto the carrier, amplify it, and transmit it on the spectrum.

FIG. 11 illustrates that the baseband OFDM symbol s includes two contributions, i.e., (i) the contribution from the WUS s^{W} (the WUS part of the OFDM symbol) and (ii) the contribution from the data signal s^{O}. s^{W} is the WUS part of the OFDM symbol s modulated on the WUS subcarriers associated with the channels 1552; and s^{O} is the part of the OFDM symbol s^{O} modulated on the subcarriers associated with the channels 1551, 1553:

$$\begin{matrix}s = {s}^{W} + {s}^{O} \\ = [ \begin{matrix}{ω}^{{k}_{c} 0} {\tilde{b}}_{0} \\ ⋮ \\ {ω}^{{k}_{c} ( N - 1 )} {\tilde{b}}_{N - 1}\end{matrix} ] + [ \begin{matrix}{s}_{0}^{O} \\ ⋮ \\ {s}_{N - 1}^{O}\end{matrix} ] \\ = diag ( {ω}^{{k}_{c} 0} , … , {ω}^{{k}_{c} ( N - 1 )} ) \tilde{b} + {s}^{O}\end{matrix} . \qquad ( 6 )$$

The WUS part s^{W} of the OFDM symbol s corresponds to the WUS 4003.

In FIG. 11, the signal shaping block 1501 is configured to shape the reference WUS waveform b such that the baseband representation of the WUS part s^{W} of the OFDM symbol s, i.e., \tilde{b}, is approximately equal to b. Such an approach allows for orthogonality between waveforms x₀, x₁ and \tilde{x} when included in the same OFDM symbol s. This is achieved by communicating the WUS 4003, s^{W} as an OFDM-based modulated signal. The signal shaping block 1501 calculates the necessary input \tilde{x} to the IFFT block 1502 on the subcarriers 811-813 designated for the WUS 4003 which is needed to approximate a desired reference WUS waveform b in the time domain. Thereby, the WUS part s^{W} of the resulting OFDM symbol s can be detected by a WURX or a MRX in a low-power state without the need for further synchronization and without knowledge of the current setting of the OFDM numerology, in particular the SCS, while still being orthogonal to the other parts s^{O} of the OFDM signal s.

This gives the flexibility to implement various signal designs (i.e., use various signal design parameters, cf. FIG. 10) of the reference WUS waveform b such that if it was directly received by the WURX or the MRX in the low-power state, it would appropriately wake-up the UE 101.

As a general rule, various options are available to implement the signal shaping of the signal shaping block 1501. In one example option, a look-up table may be provided. The look-up table may translate between the reference WUS waveform b and the WUS waveforms \tilde{x}. Thereby, look-up table may have various entries that relate to different possible reference WUS waveforms b. In a further example option, an optimization may be implemented. For this, a feedback path may be implemented that provides a feedback of \tilde{b} to the signal shaping block 1501. Then, an iterative optimization algorithm may be employed that—e.g., in a numerical simulation—varies the output of the signal shaping block 1501, i.e., \tilde{x}, until an optimization criterion is met; the optimization criterion can correspond to a difference between the reference WUS waveform b and \tilde{b}. In a further example, the shaping can be based on an analytic approximation of the OFDM modulator 1502-1504. For example, it would be possible that the shaping is based on an approximation of the IFFT block 1502. The approximation of the IFFT block 1502 can be denoted \tilde{F}. Here, \tilde{F} can be a sub-matrix of F. The dimension of \tilde{F} can be N×K, see Eqs. (1)-(4). For example, it would be possible to select the WUS-subcarriers K symmetrically around the center subcarrier k_{c}. Thereby, the output of the IFFT block 1502 can be approximated, but orthogonality to the data signal waveforms is maintained.

Specifically, it would be possible that the signal shaping at the signal-shaping block 1501 minimizes a difference between \tilde{b} and b. As a general rule, various metrics can be considered to define the difference.

FIG. 13 illustrates aspects with respect to such a signal shaping. In FIG. 13, the dashed line illustrates the reference WUS waveform b and the full line illustrates the baseband representation \tilde{b} of the WUS part s^{W} of the OFDM symbol s. As illustrated in FIG. 13, \tilde{b}≈b.

FIG. 13 is provided for b being mapped to symbols of OOK, using an N=2048 IFFT OFDM system and carrying the WUS on K=64 consecutive subcarriers (out of 72 designated ones). The signals are shown for one full OFDM symbol (2048 time samples) without the cyclic prefix.

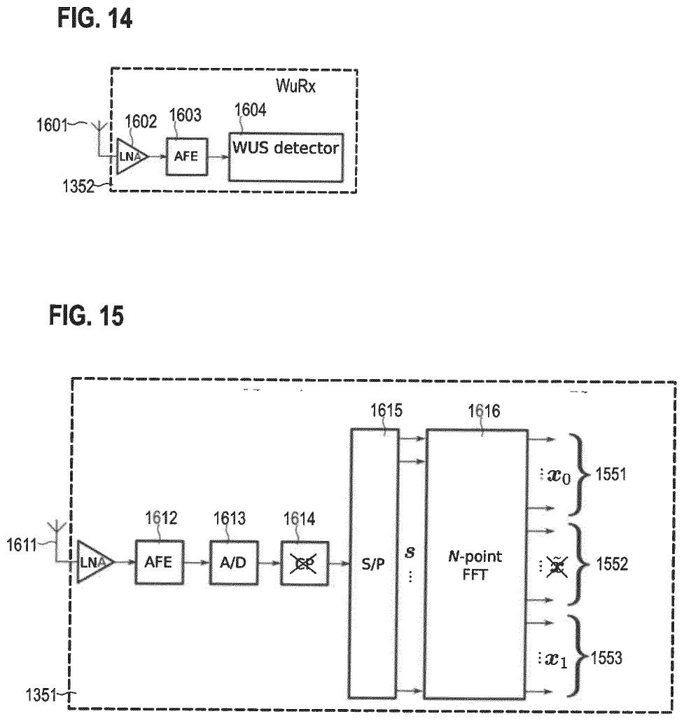

This facilitates employing a WURX 1352 or the MRX 1351 in the low-power state for receiving the WUS part s^{W} of the OFDM symbol s, cf. FIG. 14.

FIG. 14 illustrates aspects with respect to the WURX 1352. The WURX 1352 is coupled to an antenna 1601. The WURX 1352 may include a bandpass filter that restricts the receive bandwidth to the subcarriers 811-813 for WUS transmission (cf. FIG. 4). The WURX 1352 includes an analog frontend that may perform demodulation from the carrier. A non-coherent WUS detector 1604 is provided which is configured to demodulate the respective waveform in accordance with the non-coherent modulation scheme associated with the reference WUS waveform b. For the non-coherent demodulation, a synchronization signal needs not to be received first. The SCS need not be known. Rather, time-domain processing in accordance with OOK-demodulation or FSK-demodulation reference implementations is possible. The transmitter of the OFDM symbol and the receiver of the OFDM symbol need to be synchronized.

FIG. 15 illustrates aspects with respect to the MRX 1351. The MRX 1351 is coupled to an antenna 1611. The MRX 1351 includes a low noise amplifier 1612, an analog-to-digital converter 1613, a cyclic prefix removal block 1614, a serial-to-parallel conversion 1615, and an FFT block 1616. The FFT block 1616 outputs multiple channels 1551-1552. The channels 1552 include the WUS waveform \tilde{x} which, however, can be discarded, because the MRX 1351 is already in active state. The blocks 1614-1616 hence form an OFDM de-modulator.

As a general rule, techniques as described above with time-domain processing in accordance with 00K-demodulation or FSK-demodulation are optional. In other examples, an OFDM modulation may be applied for the WUS 4003, as well. Then, the OFDM demodulator according to blocks 1614-1616 of the MRX 1351 can be employed to receive the WUS 4003.

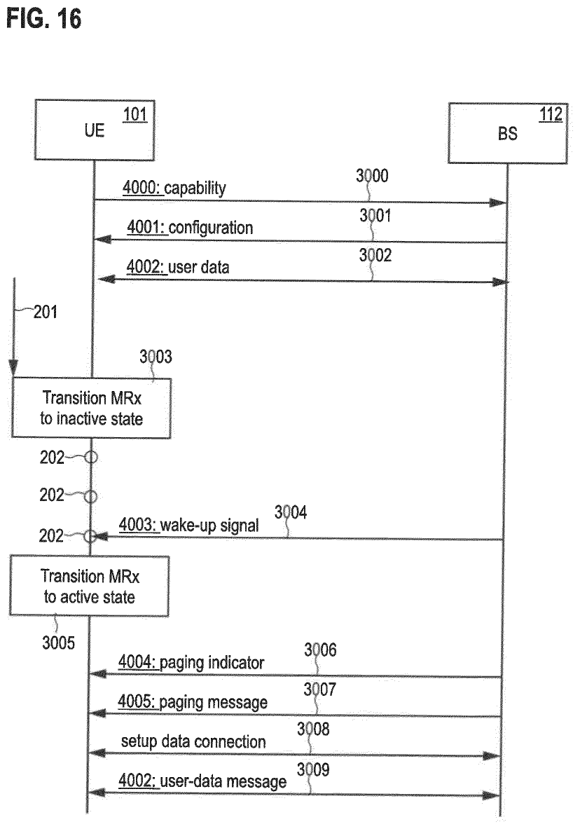

FIG. 16 is a signaling diagram. FIG. 16 illustrates aspects with respect to communicating between the UE 101 and the BS 112. FIG. 16 illustrates aspects with respect to communicating a WUS 4003. In particular, FIG. 16 also illustrates aspects with respect to the inter-relationship between communication of a WUS and communication of paging indicators 4004 and paging messages 4005 at a PO 202 that may be employed in the various examples described herein.

At 3000, a—generally optional—capability control message 4000 is communicated. The capability control message 4000 is transmitted by the UE 101 and received by the BS 112. For example, the capability control message 4000 may be communicated on a control channel, e.g., the physical uplink control change (PUCCH). For example, the capability control message 4000 may be a Layer 2 or Layer 3 control message. The capability control message 4000 may be relate to RRC/higher-layer signaling.

As will be explained in further detail below, the capability control message 4000 includes UL control information generally related to WUS capabilities of the respective UE.

The uplink (UL) control information included in the capability control message 4000 can be indicative of one or more of the following information: a receive BW capability of the WURX 1352 or the low-power state of the MRX 1351; a data rate capability of the WURX 1352 or of the low-power state of the MRX 1351; a decoding and/or demodulation capability of the WURX 1352 or the low-power state of the MRX 1351. In some examples, it would also be possible that the UL control information included in the capability control message 4000 includes an explicit indication of constraints for values of the one or more signal design parameters of the WUS 4003.

Based on such and other WUS capabilities, the BS 112 can then determine appropriate values for one or more signal design parameters for generating the WUS 4003 (details with respect to the signal design parameters have been described in connection with FIG. 10).

At 3001, a—generally optional—configuration control message 4001 is communicated. The configuration control message 3001 is transmitted by the BS 112 and received by the UE 101. The configuration control message 4001 includes DL control information. The DL control information is indicative of the determined values of the one or more signal design parameters of the WUS 4003. Thereby, the UE 101 can appropriately configure its WURX 1352 or the low-power state of the MRX 1351 to receive the WUS 4003.

As a general rule, the DL configuration control message 4001 could be indicative of further information required by the UE 101 to receive the WUS 4003. To give an example, DL control information included in the configuration control message 4001 could be indicative of the current setting of the adaptive OFDM numerology used for transmitting the WUS 4003 later on. For example, the DL control information could be indicative of a count of one or more subcarriers used for the WUS 4003.

As has been explained above, at least in some scenarios the UE 101 may not require such information on the setting of the OFDM numerology to be used when transmitting the WUS 4003 (cf. explanations in connection with FIG. 14).

At 3002, a user data 4002 is communicated. For example, the user data 4002 may be communicated on the payload channel 263. For example, the user data 4002 may be communicated along the data connection 189, e.g., as part of a bearer, etc.

The messages 4000, 4001 and the user data 4002 are communicated using the MRX 1351 in the high-power state.

Then, there is no more data to be communicated between the UE 101 and the BS 112. Transmit buffers are empty. This may trigger a timer. For example, the timer may be implemented at the UE 101. After a certain timeout duration set in accordance with the inactivity schedule 201, the MRX 1351 of the UE 101 is transitioned into a shut-down state or a low-power state, 3003. This is done to reduce the power consumption of the UE 101. For example, prior to the transitioning the MRX 1351 to the low-power state or shut-down state, it would be possible to release the data connection 189 by appropriate control signaling (not illustrated in FIG. 16). The timeout duration 201 is an example implementation of a trigger criterion; other trigger criteria are possible. For example, a connection release message may be communicated.

Multiple POs 202 for communicating the WUS 4003 are then implemented.

At some point in time, the BS 112 transmits a WUS 4003, at 3004. This may be because there is DL data—e.g., payload data or control data—scheduled for transmission to the UE 101 in a transmit buffer. The WUS 4003 is received using the WURX 1352 or the MRX 1351 in the low-power state.

The WUS 4003 is transmitted before or at a PO 202. This can be aligned with a DRX cycle of the WURX 1352 or the MRX 1351 in the low-power state.

In response to receiving the WUS 4003, the MRX 1351 of the UE 101 is transitioned to the high-power state.

Then, at 3006, a paging indicator 4004 is transmitted by the BS 112 to the UE 101. The paging indicator 4004 is received by the MRX 1351. For example, the paging indicator may be transmitted on channel 262, e.g. PDCCH. For example, the paging indicator may include a temporary or static identity of the UE 101. The paging indicator 4004 may include information on a modulation and coding scheme used for communicating a paging message 4005 at 3007. The paging message 4005 may be communicated on a shared channel 263, e.g., physical DL shared channel (PDSCH).

Then, at 3008, a data connection 189 is set up between the UE 101 and the BS 112. This may include a random access procedure.

Finally, a UL or DL user-data message 4002 is communicated using the newly set up data connection 189 at 3009.

As will be appreciated from FIG. 16, upon transitioning the MRX 1351 to the active state at 3005, the data connection 189 needs to be re-established. For this reason, the UE 101 operates in idle mode 302—when no data connection 189 is set up or maintained. However, in the various examples described herein, other implementations of the particular mode in which the UE 101 operates when monitoring for the WUS 4003 are conceivable: For example, the UE 101 may operate in connected mode 301.

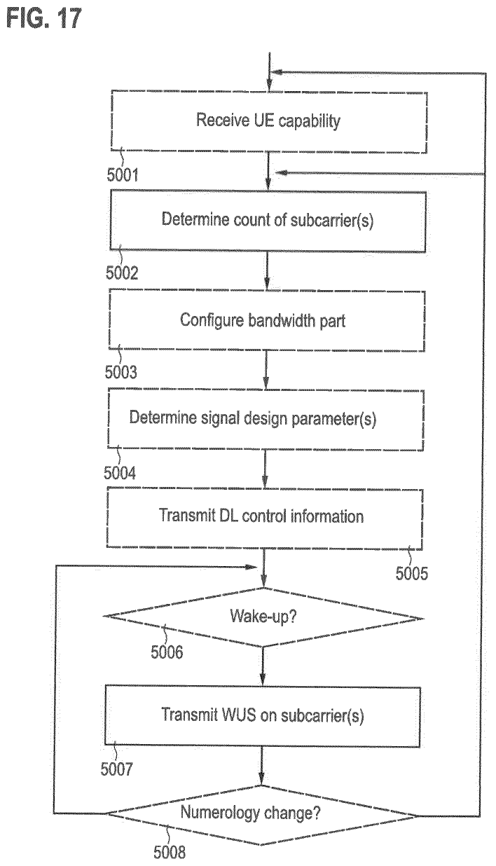

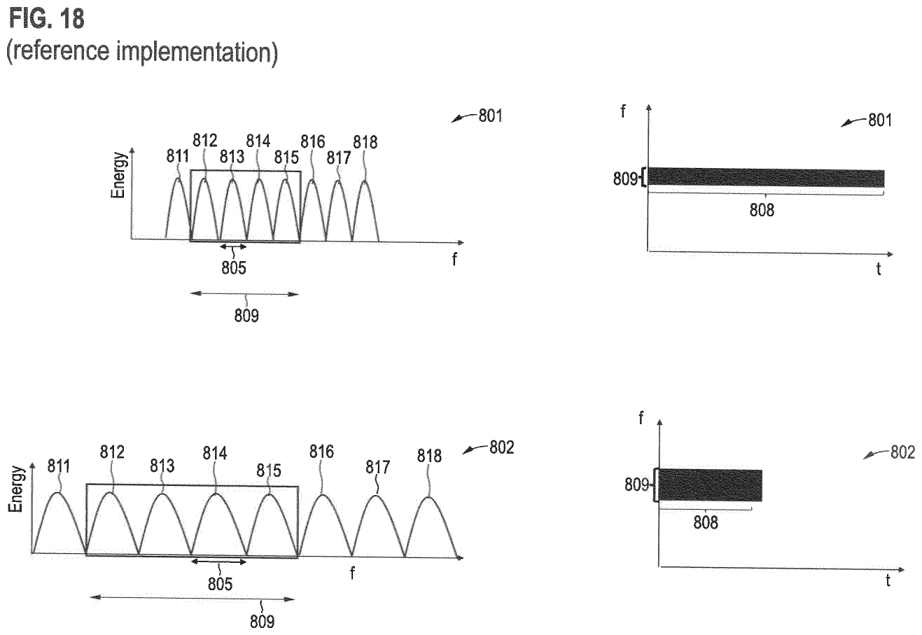

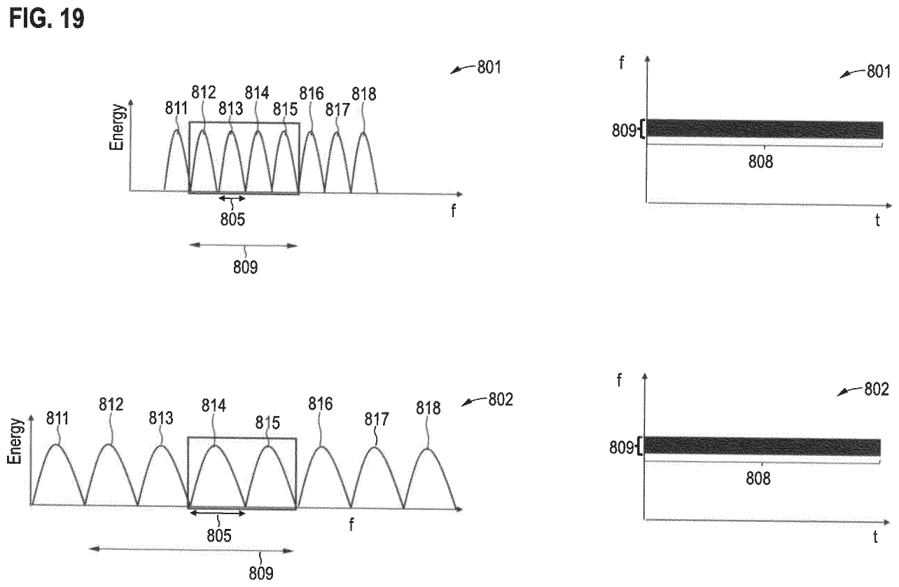

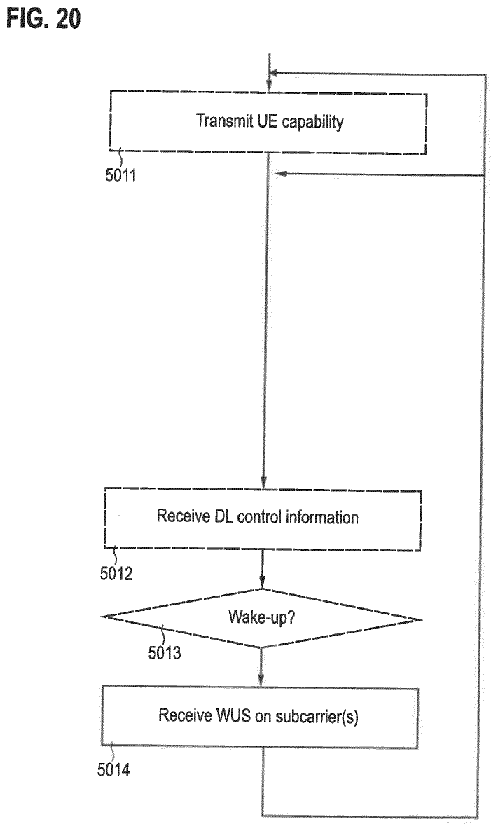

Next, details with respect to techniques of dynamically determining a mapping of a WUS to one or more subcarriers depending on a setting of an adaptive modulation numerology of the corresponding carrier are described, in connection with FIG. 17, FIG. 18, FIG. 19, and FIG. 20.

FIG. 17 is a flowchart of a method according to various examples. Optional blocks are labeled with dashed lines in FIG. 17. The method of FIG. 17 could be executed by the control circuitry 1122 of the BS 112 (cf. FIG. 6), e.g., upon loading program code from the memory 1123 and executing the program code. Various examples are described below in connection with such an implementation in which the method is executed by the BS 112; but in similar techniques the method may be readily executed by other nodes or devices.

At optional block 5001, the BS 112 receives UL control information from the UE 101. The UL control information is indicative of one or more WUS-related capabilities of the UE 101. To give a few examples, the UL control information could be indicative of a receive bandwidth capability of the WURX 1352 or the MRX 1351 in the low-power state; the UL control information could be alternatively or additionally be indicative of a data rate capability of the WURX 1352 or the MRX 1351 in the low-power state; and/or could be indicative of a decoding and/or demodulation capability of the WURX 1352 or the low-power state of the MRX 1351; and/or constraints for values of one or more signal design parameters of the WUS 4003.

In detail, the receive bandwidth capability could specify a maximum bandwidth of the WURX 1352 or the low-power state of the MRX 1351. For example, such a maximum received bandwidth could be limited by hardware bandpass filters of the analog front end. It would also be possible that the receive bandwidth capability specifies whether or not the analog front end of the wireless interface 1011 of the UE 101 is capable of dynamically adjusting the received bandwidth (i.e., tunable bandpass filters) or even the extent with which the receive bandwidth can be adjusted.

The decoding and/or demodulation capability of the WURX 1352 or the low-power state of the MRX 1351 could specify modulation and/or coding types or constellations or formats that are supported by the WURX 1352 or the MRX 1351 in the low-power state. For example, in connection with FIG. 10 certain signal design parameters have been explained and it would be possible that the decoding and/or demodulation capability specifies certain properties or thresholds or constraints for these signal design parameters. For example, the demodulation capability could specify whether the UE 101 has the capability of performing OFDM demodulation by the WURX 1352 or the low-power state of the MRX 1351.

For example, the constraints for values of one or more signal design parameters of the WUS could specify certain maximum or minimum values of, e.g., the base sequence length, scrambling factor, the forward error correction, the checksum, etc. as explained above in connection with FIG. 10.

As a general rule, the UL control information in block 5001 that is indicative of the UE capability could be received as a RRC control message (cf. FIG. 16: 3000). It would also be possible that corresponding information is, e.g., piggybacked to a random access message, e.g., using random-access preamble partitioning.

Further, while various examples have been described in which the UL control information is received from the UE 101, in other examples, it would be possible that UE capability information including such information is received from a UE context stored in the core network 115 of the cellular network 100 (cf. FIG. 1).

Next, at block 5002, a count of one or more subcarriers of the carrier of the wireless link 114 is determined. The one or more subcarriers are for transmission of the WUS 4003 to the UE 101. At block 5002, the count is determined depending on an active/current setting of an adaptive OFDM numerology of the carrier.

As has been explained above in connection with Table 1, different numerologies can differ with respect to various characteristics, e.g., SCS, slot length, or a number of slots per subframe, and cyclic prefix length. All such and other characteristics can be taken into account as the setting of the adaptive modulation numerology in block 5002, i.e., all such settings can be taken as a input to the determining of the count of the one or more subcarriers 811-813.

One particular characteristic of the numerology is the SCS 805. It has been found that the SCS 805 can have a significant impact on the functioning of the wake-up signaling. Therefore, according to various examples, it is possible to determine the count of the one or more subcarriers 811-813 depending on the SCSs 805 of the one or more subcarriers 811-813.

Further, as a general rule, various design rules can be taken into account when executing block 5002, i.e., when determining the count of the one or more subcarriers at 811-813. For example, a predefined scaling rule could be used that translates the current setting of the adaptive modulation numerology, in particular the current SCS, into the count of the one or more subcarriers 811-813. According to various examples, it would be possible that the count of the one or more subcarriers 811-813 is determined using an inverse scaling factor. The inverse scaling factor can be between (i) the SCS defined by the setting of the adaptive modulation numerology, and (ii) the count of the one or more subcarriers used for transmitting the WUS. This means that a larger SCS can result in a lower count of the one or more subcarriers 811-813. This helps to avoid an increase of the bandwidth allocated to the WUS with increasing SCS.

According to various examples, it would be possible to determine the count of the one or more subcarriers 811-813 such that the WUS BW remains substantially constant. “Substantially” constant can correspond to a variation of the bandwidth with variation in the SCS to amount to not more than 20%.

In detail, it would be possible that a first count of the one or more subcarriers 811-813 is determined for a first SCS defined by the setting of the adaptive modulation numerology. The first count of the one or more subcarriers can define a first WUS BW. Then, a second count of the one or more subcarriers can be determined for a second SCS defined by the setting of the adaptive modulation numerology. Herein, the second count of the one or more subcarriers can define a second WUS BW. The first WUS BW could be within a range of 80% to 120% of the second WUS BW.

At the same time, it would be possible that the signal design parameters do not significantly change for the transmission using the first SCS or the transmission using the second SCS. In other words, the waveform of the WUS can remain essentially unchanged, irrespective of the current setting of the adaptive modulation numerology (cf. FIG. 13). Thus, in detail, the WUS having the first bandwidth can be transmitted in accordance with first values of signal design parameters and the WUS having the second bandwidth can be transmitted in accordance with second values of the signal design parameters. The first values of the signal design parameters can be the same as the second values of the signal design parameters. Example implementations of the signal design parameters have been explained above in connection with FIG. 10.

Such novel and unconventional bandwidth-constant signal design would be suitable for wake up signaling, compared to the existing bandwidth-varying decoding that otherwise is required for an 3GPP-comparable MRX 1351. The purpose for defining such a configuration is to guarantee enabling low-power design of the WURX 1352 or the low-power state of the MRX 1351. Other signals transmitted on the wireless link 114 are scaling their BW according to changes in the setting of the OFDM numerology. In some scenarios, a synchronization signal is not required to be detected prior to receiving the WUS 4003 (cf. FIG. 13), and therefore, the UE 101 only needs to monitor this new narrowband channel when the UE 101 is in the WUS detection mode (with the WURX 1352 or the low-power state of the MRX 1351 activated). When the WUS 4003 is detected, the UE 101 switches to detect a synchronization signal on larger bandwidth. This new bandwidth configuration can be applied for both connected and idle/inactive modes 301, 302.

The WUS 4003 is designed to occupy a given determined WUS BW (and a certain data-rate) independent of the SCS. This means the WUS would have fixed bandwidth independent of the SCS while other synchronization/control/data signaling still would scale its bandwidth according to the SCS. This therefore differs from reference WUS designs, by allowing a fixed bandwidth even if SCS is changed, while prior art WUS designs scales bandwidth with SCS. This can be implemented by selecting a certain number count of subcarriers, K, having a certain SCS, Δf, which represents the determined bandwidth/data rate for low-power detection. If network needs to transmit the WUS 4003 using a different setting of the OFDM numerology, it adjusts the number/count of subcarriers accordingly. Through this, the bandwidth and the time considered for the WUS detection remains the same and have no influence on signal detection and the corresponding performance at the receive side.

The determining of the count of subcarriers can be enabled through signaling of assistance information (UL control information 4000), to support the network in the design of suitable WUS 4003. This could be implemented by the UE 101 providing the UL control information 4000 (block 5001), where the UE 101 indicates a configuration providing suitable characteristics of the WUS 4003. Examples of such configuration information could be: data rate, bandwidth, sequence type, number of bit-information carried by the WUS/sequence. Hence, the UE 101 could indicate suitable WUS design e.g. dependent on service type which would change for example the amount of required information in the WUS 4003 for different connection setup latency. The more information included in the WUS 4003, the longer time to detect the WUS 4003 (larger WUS detection energy consumption), but the shorter connection setup time can be achieved (e.g. by allocating resources within WUS or similar).

Thus, as a general rule, when determining the count of the subcarriers at block 5002, it would be possible to take into account the UL control information received as part of block 5001.

As a general rule, the UL control information may also be taken into account when determining the setting of the adaptive OFDM numerology.

In the various examples herein, concepts of BWP adaption can be combined with the concepts of wake-up signaling. For example, it would be possible that, in block 5002, the count of the one or more subcarriers is furthermore determined based on a BWP 371, 372 or a sub-BWP 373 of the carrier of the wireless link 114. To give an example, the BWP 371 (cf. FIG. 3) may be predefined for the OFDM numerology 801 having a unique setting. Then, it would be possible to determine the count of the one or more subcarriers such that the WUS 4003 has a WUS BW that fits within the bandwidth of the BWP 371.

On the other hand, in various examples it would also be possible that the BWP 371, 372 or the sub-BWP 373 is configured in accordance with the WUS BW that is defined by the count of the one or more subcarriers 811-813. This is implemented in optional block 5003. For example, a new BWP may be defined that is statically or dynamically reserved for transmission of the WUS 4003 to the UE 101, or optionally to one or more further UEs.

In this regard of BWP configuration, at least the following options are available:

Option 1: A dedicated new BWP in addition to legacy BWPs available in 3GPP NR standard, to carry the WUS 4003, in addition to any existing BWP configurations.

Option 2: A dedicated new BWP to carry multiple WUSs (including the WUS 4003 for the UE 101) for multiple UEs. This is also in addition to any existing BWP configurations. Here, system would perform frequency domain multiplexing of the WUS in a BWP. Note: A UE does not necessarily have to monitor the whole new BWP. It may only needs to monitor a portion of this new BWP.

Option 3: A dedicated sub-BWP to carry the WUS 4003 within any existing BWP configurations, where the whole BWP can be used for any data transmission by NR when the WUS is not transmitted, or if the WUS is reallocated.

Option 4: A dedicated sub-BWP to carry multiple WUSs (including the WUS 4003) for multiple UEs within any existing BWP. Here, system would perform frequency domain multiplexing of the WUS in a sub-BWP. Note: A UE does not have to monitor the whole new sub-BWP. It may only needs to monitor a portion of this new sub-BWP.

Thus, as will be appreciated, in option 1 and option 2 and option 4, the corresponding BWP 371, 372 or the corresponding sub-BWP 373 is statically reserved for the transmission of WUSs. In option 3, a dynamic reservation is provided, with multiplexing of data transmission.

Next, in optional block 5004, one or more signal design parameters of the WUS 4003 are determined. Corresponding DL control information can be transmitted to the UE 101 in block 5005. The DL control information can be indicative of the one or more signal design parameters as determined in block 5004. Details with respect to transmitting the DL control information have been explained above in connection with FIG. 16: 3001 where the DL configuration control message 4001 is transmitted.

In some scenarios, the signal design parameters of the WUS are dynamically determined, depending on the count of the one or more subcarriers. In other examples, it would be possible that the WUS is predefined, irrespective of the count of the one or more subcarriers.

As a general rule, it would be possible that the DL control information is indicative of the count of the one or more subcarriers as determined as part of block 5002. This can help the UE 101 to appropriately configure the WURX 1352 or the MRX 1351 in the low-power state for receiving the WUS 4003.

Next, at block 5006 it is checked whether a wake-up event occurs. Prior to block 5006, the UE 101 might have transitioned into an idle mode 302 (albeit it would also be possible to use WUSs during, e.g., the connected mode 301, e.g., in combination with a DRX cycle).

Possible wake-up events as part of block 5006 include: paging trigger from the AMF 131; DL data in a transmit buffer; a paging occasion 202; etc.

Next, at block 5007, if a wake-up event has been detected in block 5006, the WUS 4003 is transmitted on the one or more subcarriers, according to the count as determined in block 5002.

In block 5008, it is checked whether there is a change in the numerology. If not, then there is no need to re-execute blocks 5002-5005. Otherwise, blocks 5002-5005 are re-executed, if the setting of the OFDM numerology has changed.

FIG. 18 illustrates reference implementations. FIG. 18 illustrates aspects with respect to a change in the setting of the numerology 801, 802, e.g., as detected as part of block 5008.

In FIG. 18, the overlap between the subcarriers 811-818 is not illustrated for sake of legibility. However, the subcarriers 811-818 can have an overlap (e.g., cf. FIG. 4).

FIG. 18, upper part, illustrates a first setting in accordance with the OFDM numerology 801. Here, a comparably small SCS 805 of multiple subcarriers 811-818 is present. A corresponding WUS BW 809 is illustrated. Also illustrated is a duration 808 required to transmit the WUS 4003.

FIG. 18, bottom part, illustrates a second setting of the OFDM numerology 802, having an increased SCS 805 of the subcarriers 811-818. In the reference implementation according to FIG. 18, the count of the subcarriers 812-815 (here: four subcarriers) used for the transmission of the WUS 4003 is not changed. Accordingly, the WUS BW 809 increases; at the same time, the transmission duration 808 decreases.

FIG. 19 illustrates aspects with respect to determining the count of the one or more subcarriers used to transmit the WUS 4003 according to various examples. In FIG. 19, the overlap between the subcarriers 811-818 is not illustrated for sake of legibility. However, the subcarriers 811-818 can have an overlap (e.g., cf. FIG. 4).

FIG. 19 generally corresponds to FIG. 18. However, for the second setting in accordance with the OFDM numerology 802, the count of the subcarriers 814, 815 is determined such that the bandwidth 809 for the transmission of the WUS 4003 remains essentially constant, irrespective of the SCS 805 (the count of subcarriers is reduced from four for the setting in accordance with the OFDM numerology 801 to two for the setting in accordance with the OFDM numerology 802). Therefore, also the time duration 808 for transmission of the WUS 4003 remains essentially constant. Such an essentially constant WUS BW 809 facilitates a limited receive bandwidth of an analog front end of the UE 101. Details with respect to the UE operation will be explained next in connection with FIG. 20.

FIG. 20 is a flowchart of a method according to various examples. Optional blocks are labeled with dashed lines in FIG. 20. For example, the method of FIG. 20 may be executed by the control circuitry 1012 of the UE 101. While various examples will be described hereinafter in connection with the UE 101 performing the method according to FIG. 20, similar techniques may be readily employed for other kinds and types of UEs or wireless communication devices executing the method of FIG. 20.

At optional block 5011, the UE 101 transmits the UL control information 4000. As such, block 5011 is interrelated to block 5001 (cf. FIG. 17).

The UL control information 4000 is transmitted to the cellular network 100. The UL control information is indicative of at least one of the following: a receive bandwidth capability of the WURX 1352 or the low-power state of the MRX 1351; a data rate capability of the WURX 1352 or the low-power state of the MRX 1351; a decoding and/or demodulation capability of the WURX 1352 or of the low-power state of the MRX 1351; constraints for values of one or more signal design parameters of the WUS 4003. The UL control information 4000 aids the cellular network 100 in determining the count of one or more subcarriers for the WUS 4003 and/or aids the cellular network 100 in determining one or more values of signal design parameters of the WUS 4003.

Next, at optional block 5012, DL control information may be received. As such, block 5012 is interrelated to block 5005 (cf. FIG. 17). The DL control information is received from the cellular network 100. It can be indicative of at least one of the count of one or more subcarriers for transmission of the WUS 4003 or, more generally, the active setting of the adaptive OFDM numerology.

According to some examples, it is possible that, later on, in case a wake-up event occurs at block 5013, the WUS 4003 is received based on the DL control information, block 5014. I.e., the receiving—e.g., the decoding or the demodulation—can be configured in accordance with the DL control information as received in block 5012. For example, this may be helpful in scenarios in which the WURX 1352 or the low-power state of the MRX 1351 relies on an OFDM demodulation (cf. FIG. 15). However, in other scenarios, this may not be required, e.g., in cases where a time-domain processing without prior demodulation is sufficient to receive the WUS 4003 (cf. FIG. 14). Here, knowledge on the count of the one or more subcarriers 811-818 used for transmitting the WUS 4003 or knowledge on the active setting of the adaptive OFDM numerology may not be required to successfully receive the WUS 4003. For instance, in such a scenario according to, e.g., FIG. 14, it would be possible that the DL control information indicative of the setting of the adaptive OFDM numerology is only received after and upon receiving the WUS, e.g., when transitioning the MRX 1351 into the high-power state. Then, subsequent OFDM-modulated signals can be received based on the setting of the adaptive modulation numerology as indicated by the DL control information. On the other hand, the WUS 4003 can be received on the predefined WUS BW that remains essentially constant, irrespective of the SCS 805.

In FIG. 20, blocks 5011-5014 or block 5012-5014 can be re-executed (i.e., for multiple iterations, the UE capability according to block 5011 may or may not be re-executed, depending on the implementation)—i.e., for multiple transitions back-and-forth between the connected mode 301 and the idle mode 302. For multiple iterations, the WUS 4003 can be received multiple times, e.g., at different wake-up events. The WUS—e.g., having fixed values of the signal design parameters and thus having a fixed waveform—can be received on different counts of one or more subcarriers 811-818; while the WUS BW can remain essentially constant, e.g., within a range of 80% to 120%.

Summarizing, techniques have been described in which a WUS is mapped to a variable count of subcarriers, depending on a current setting of an adaptive OFDM numerology. Thereby, the bandwidth for the WUS can remain essentially constant.

In particular, the following processes have been described in detail above:
The cellular network is configured with one or more BWPs where each BWP uses a certain OFDM numerology (same or different in different BWPs).
The UE informs network about a suitable WUS configuration/bandwidth.
The cellular network configures a setting of the adaptive modulation numerology to use for the WUS. This can be done on per-UE basis or for entire wireless network cell.
The cellular network determines, based on determined WUS BW and the active setting of the modulation numerology, values for the WUS signal design parameters, as well as e.g., count of subcarriers to allocate for WUS and optionally time allocations (duration and periodicity) and frequency allocations (within one of the existing BWPs or as a new BWP).
The cellular network optionally informs UE about the properties. This could be informed as index from a lookup table, or direct configuration information.
Then, the WUS signal is transmitted/received.

This process could be repeated/activated also for when the setting of the adaptive OFDM numerology is updated. In such scenario the following steps could be used:
The setting of the adaptive OFDM numerology is updated, e.g. based on the use case to be supported (switching to accommodate for lower latency communication), or based on moving the communication with the UE to another frequency range or similar.
Then, the cellular network determines, based on the updated numerology, “updated” count of subcarriers to allocate for WUS signal, in order to keep the WUS BW fixed. This could also be coupled to update of the frequency and timing properties. As a general rule, the network could for example scale the number of subcarriers directly with the SCS for the same amount of information. Note that for a given time duration of a transmission a doubled SCS reduces the time per symbol with 50%, so the same amount of information can be included.
Then, the “updated” WUS signal is transmitted/received.

Thus, the following EXAMPLEs have been described:

### EXAMPLE 1

A method of operating an access node (112) of a communication network (100), the method comprising:
determining a count of one or more subcarriers (811-818) of a carrier (370) depending on a setting of an adaptive modulation numerology of the carrier (370), and
transmitting a wake-up signal (4003) to a wireless communication device (101) on the one or more subcarriers (811-818).

### EXAMPLE 2

The method of EXAMPLE 1,
wherein different settings of the adaptive modulation numerology are associated with different subcarrier spacings (805) of the one or more subcarriers (811-818).

### EXAMPLE 3

The method of EXAMPLE 2,

wherein the count of the one or more subcarriers (811-818) is determined using an inverse scaling factor between subcarrier spacing (805) and the count of the one or more subcarriers (811-818).

### EXAMPLE 4

The method of EXAMPLE 2 or 3,
wherein a first count of the one or more subcarriers (811-818) is determined for a first subcarrier spacing (805) defined by the setting of the adaptive modulation numerology, the first count of the one or more subcarriers (811-818) defining a first bandwidth (809) for the wake-up signal (4003),
wherein a second count of the one or more subcarriers (811-818) is determined for a second subcarrier spacing (805) defined by the setting of the adaptive modulation numerology, the second count of the one or more subcarriers (811-818) defining a second bandwidth (809) for the wake-up signal (4003),
wherein the first bandwidth (809) is within a range of 80% to 120% of the second bandwidth (809).

### EXAMPLE 5

The method of EXAMPLE 4,
wherein the wake-up signal (4003) having the first bandwidth (809) is transmitted in accordance with first values of signal design parameters of the wake-up signal (4003),
wherein the wake-up signal (4003) having second bandwidth (809) is transmitted in accordance with second values of the signal design parameters,
wherein the first values of the signal design parameters are the same as the second values of the signal design parameters.

### EXAMPLE 6

The method of any one of the preceding EXAMPLEs,
wherein the count of the one or more subcarriers (811-818) defines a frequency bandwidth (809) for the wake-up signal (4003),
wherein the method further comprises:
   configuring a bandwidth part (371, 372) or sub-bandwidth part (373) of the carrier (370) in accordance with the frequency bandwidth (809) for the wake-up signal (4003).

### EXAMPLE 7

The method of any one of the preceding EXAMPLEs,
wherein the count of the one or more subcarriers (811-818) is further determined depending on a bandwidth part (371, 372) or a sub-bandwidth part (373) of the carrier (370).

### EXAMPLE 8

The method of EXAMPLE 6 or 7,
wherein the bandwidth part (371, 372) or sub-bandwidth (373) is statically reserved or dynamically reserved for transmission of wake-up signals (4003) to the wireless communication device (101) and optionally one or more further wireless communication devices.

### EXAMPLE 9

The method of any one of the preceding EXAMPLEs, further comprising:
receiving uplink control information (4000) from the wireless communication device (101), the uplink control information (4000) being indicative of at least one of the following: a receive bandwidth capability of a low-power receiver or low-power receiver state of the wireless communication device; a data rate capability of the low-power receiver or low-power receiver state; a decoding and/or demodulation capability of the low-power receiver or low-power receiver state; or constraints for values of one or more signal design parameters of the wake-up signal;
wherein at least one of the count of the one or more subcarriers and the setting of the adaptive modulation numerology is further determined depending on the uplink control information (4000).

### EXAMPLE 10

The method of any one of the preceding EXAMPLEs, further comprising:
determining values of one or more signal design parameters of the wake-up signal (4003) depending on the count of the one or more subcarriers (811-818), and
transmitting downlink control information (4001) to the wireless communication device, the downlink control information (4001) being indicative of the one or more signal design parameters.

### EXAMPLE 11

The method of any one of the preceding EXAMPLEs, further comprising:
transmitting downlink control information (4001) to the wireless communication device (101), the downlink control information (4001) being indicative of the count of the one or more subcarriers (811-818).

### EXAMPLE 12

A method of operating a wireless communication device (101), the method comprising:
receiving a wake-up signal (4003) on a first count of one or more subcarriers (811-818) of a carrier (370) in a first setting of an adaptive modulation numerology (801, 802) of the carrier (370), the first count of the one or more subcarriers defining a first bandwidth (809) for the wake-up signal (4003),
receiving the wake-up signal (4003) on a second count of the one or more subcarriers (811-818) of the carrier (370) in a second setting of the adaptive modulation numerology (801, 802) of the carrier (370), the second count of the one or more subcarriers (811-818) defining a second bandwidth (809) for the wake-up signal (4003), the second count being different from the first count,

wherein the first bandwidth (809) is within a range of 80% to 120% of the second bandwidth (809).

### EXAMPLE 13

The method of EXAMPLE 12, further comprising:
receiving downlink control information (4001) indicative of at least one of the first count of the one or more subcarriers (811-818), the second count of the one or more subcarriers (811-818), the first setting of the adaptive modulation numerology (801, 802), or the second setting of the adaptive modulation numerology (801, 802),
wherein said receiving of the wake-up signal (4003) is based on the downlink control information (4001).

### EXAMPLE 14

A method of operating a wireless communication device (101), the method comprising:
receiving a wake-up signal (4003) on a predefined frequency band of a carrier (370) having an adaptive modulation numerology (801, 802),
upon receiving the wake-up signal: receiving downlink control information (4001) indicative of a setting of the adaptive modulation numerology (801, 802), and
receiving a signal based on the setting of the adaptive modulation numerology (801, 802).

### EXAMPLE 15

The method of any one EXAMPLEs 12 to 14, further comprising:
transmitting uplink control information (4000) indicative of at least one of the following: a receive bandwidth capability of a low-power receiver or a low-power receiver state of the wireless communication device; a data rate capability of the low-power receiver or low-power receiver state; a decoding and/or demodulation capability of the low-power receiver or a low-power receiver state; or constraints for values of one or more signal design parameters of the wake-up signal (4003).

### EXAMPLE 16

An access node (112) of a communication network (100), the access node (112) comprising control circuitry (1122, 1123) configured to perform:
determine a count of one or more subcarriers (811-818) of a carrier (370) depending on a setting of an adaptive modulation numerology of the carrier (370), and
   transmit a wake-up signal (4003) to a wireless communication device (101) on the one or more subcarriers (811-818).

### EXAMPLE 17

The access node (112) of EXAMPLE 16, wherein the control circuitry (1122, 1123) is configured to perform the method of any one of EXAMPLEs 1 to 11.

### EXAMPLE 18

A wireless communication device (101) comprising control circuitry (1012, 1013) configured to perform:
receive a wake-up signal (4003) on a first count of one or more subcarriers (811-818) of a carrier (370) in a first setting of an adaptive modulation numerology (801, 802) of the carrier (370), the first count of the one or more subcarriers defining a first bandwidth (809) for the wake-up signal (4003),
receive the wake-up signal (4003) on a second count of the one or more subcarriers (811-818) of the carrier (370) in a second setting of the adaptive modulation numerology (801, 802) of the carrier (370), the second count of the one or more subcarriers (811-818) defining a second bandwidth (809) for the wake-up signal (4003), the second count being different from the first count,

wherein the first bandwidth (809) is within a range of 80% to 120% of the second bandwidth (809).

### EXAMPLE 19

A wireless communication device (101) comprising control circuitry (1012, 1013) configured to perform:
receive a wake-up signal (4003) on a predefined frequency band of a carrier (370) having an adaptive modulation numerology (801, 802),
   upon receiving the wake-up signal: receive downlink control information (4001) indicative of a setting of the adaptive modulation numerology (801, 802), and
   receive a signal based on the setting of the adaptive modulation numerology (801, 802).

### EXAMPLE 20

The wireless communication device (101) of EXAMPLE 18 or 19, wherein the control circuitry (1012, 1013) is configured to perform the method of any one of EXAMPLEs 12 to 15.

Although the invention has been shown and described with respect to certain preferred embodiments, equivalents and modifications will occur to others skilled in the art upon the reading and understanding of the specification. The present invention includes all such equivalents and modifications and is limited only by the scope of the appended claims.

For illustration, various examples have been described with respect to WUS techniques employed in a cellular network. Similar techniques may be readily applied to other kinds and types of networks, e.g., ad-hoc networks, infrastructure networks, etc.

For further illustration, various techniques have been described in which a WUS is transmitted on a variable count of one or more subcarriers. Similar techniques may be readily applied to other kinds and types of signals, in particular, in connection with a WURX or a low-power state of a MRX.

For still further illustration, various techniques have been described in which a WUS is transmitted while a UE operates in idle mode. Similar techniques may be readily applied to scenarios in which the UE operates in connected mode, e.g., using a DRX cycle.

1. A method of operating an access node of a communication network, the method comprising:
determining a count of one or more subcarriers of a carrier depending on a setting of an adaptive modulation numerology of the carrier, and
transmitting a wake-up signal to a wireless communication device on the one or more subcarriers.

2. The method of claim 1,
wherein different settings of the adaptive modulation numerology are associated with different subcarrier spacings of the one or more subcarriers.

3. The method of claim 2,
wherein the count of the one or more subcarriers is determined using an inverse scaling factor between subcarrier spacing and the count of the one or more subcarriers.

4. The method of claim 2,
wherein a first count of the one or more subcarriers is determined for a first subcarrier spacing defined by the setting of the adaptive modulation numerology, the first count of the one or more subcarriers defining a first bandwidth for the wake-up signal,
wherein a second count of the one or more subcarriers is determined for a second subcarrier spacing defined by the setting of the adaptive modulation numerology, the second count of the one or more subcarriers defining a second bandwidth for the wake-up signal,
wherein the first bandwidth is within a range of 80% to 120% of the second bandwidth.

5. The method of claim 4,
wherein the wake-up signal having the first bandwidth is transmitted in accordance with first values of signal design parameters of the wake-up signal,
wherein the wake-up signal having second bandwidth is transmitted in accordance with second values of the signal design parameters,
wherein the first values of the signal design parameters are the same as the second values of the signal design parameters.

6. The method of claim 1,
wherein the count of the one or more subcarriers defines a frequency bandwidth for the wake-up signal,
wherein the method further comprises:
configuring a bandwidth part or sub-bandwidth part of the carrier in accordance with the frequency bandwidth for the wake-up signal.

7. The method of claim 1,
wherein the count of the one or more subcarriers is further determined depending on a bandwidth part or a sub-bandwidth part of the carrier.

8. The method of claim 6,
wherein the bandwidth part or sub-bandwidth is statically reserved or dynamically reserved for transmission of wake-up signals to the wireless communication device and optionally one or more further wireless communication devices.

9. The method of claim 1, further comprising:
receiving uplink control information from the wireless communication device, the uplink control information being indicative of at least one of the following: a receive bandwidth capability of a low-power receiver or low-power receiver state of the wireless communication device; a data rate capability of the low-power receiver or low-power receiver state; a decoding and/or demodulation capability of the low-power receiver or low-power receiver state; or constraints for values of one or more signal design parameters of the wake-up signal;
wherein at least one of the count of the one or more subcarriers and the setting of the adaptive modulation numerology is further determined depending on the uplink control information.

10. The method of claim 1, further comprising:
determining values of one or more signal design parameters of the wake-up signal depending on the count of the one or more subcarriers, and
transmitting downlink control information to the wireless communication device, the downlink control information being indicative of the one or more signal design parameters.

11. The method of claim 1, further comprising:
transmitting downlink control information to the wireless communication device, the downlink control information being indicative of the count of the one or more subcarriers.

12. A method of operating a wireless communication device, the method comprising:
receiving a wake-up signal on a first count of one or more subcarriers of a carrier in a first setting of an adaptive modulation numerology of the carrier, the first count of the one or more subcarriers defining a first bandwidth for the wake-up signal,
receiving the wake-up signal on a second count of the one or more subcarriers of the carrier in a second setting of the adaptive modulation numerology of the carrier, the second count of the one or more subcarriers defining a second bandwidth for the wake-up signal, the second count being different from the first count,
wherein the first bandwidth is within a range of 80% to 120% of the second bandwidth.

13. The method of claim 12, further comprising:
receiving downlink control information indicative of at least one of the first count of the one or more subcarriers, the second count of the one or more subcarriers, the first setting of the adaptive modulation numerology, or the second setting of the adaptive modulation numerology,
wherein said receiving of the wake-up signal is based on the downlink control information.

14. A method of operating a wireless communication device, the method comprising:
receiving a wake-up signal on a predefined frequency band of a carrier having an adaptive modulation numerology,
upon receiving the wake-up signal: receiving downlink control information indicative of a setting of the adaptive modulation numerology, and
receiving a signal based on the setting of the adaptive modulation numerology.

15. The method of claim 12, further comprising:
transmitting uplink control information indicative of at least one of the following: a receive bandwidth capability of a low-power receiver or a low-power receiver state of the wireless communication device; a data rate capability of the low-power receiver or low-power receiver state; a decoding and/or demodulation capability of the low-power receiver or a low-power receiver state; or constraints for values of one or more signal design parameters of the wake-up signal.
